(19) United States
(12) Patent Application Publication
(10) Pub. No.: US 2004/0104866 A1
(43) Pub. Date: Jun. 3, 2004

(54) Capacitive load drive recovery circuit, capacitive load drive circuit and plasma display apparatus using the same

(75) Inventors: Yuji Sano, Kawasaki (JP); Toyoshi Kawada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 10/652,486

(22) Filed: Sep. 2, 2003

(30) Foreign Application Priority Data
Nov. 28, 2002 (JP) 2002-346165

(51) Int. Cl. G09G 3/28

(52) U.S. Cl. 345/60

(57) ABSTRACT

In the capacitive load drive power supply circuit, a transformer is used, either terminal of the primary coil of the transformer and either terminal of the second coil of the transformer are connected to an output terminal, a first switch circuit is connected between the other terminal of the primary coil and a first reference potential, a second switch circuit is connected between the other terminal of the secondary coil and a second reference potential, and a power supply switch circuit is connected between an output terminal and a drive power supply. Due to the resonance between the capacitance of a drive load and the primary coil of the transformer, the electrostatic energy stored in the capacitance of the drive load is converted into the electromagnetic energy in the exciting inductance of the primary coil of the transformer in as short a time as a quarter of the resonance period.

### BACKGROUND OF THE INVENTION

The present invention relates to a capacitive load drive circuit. More particularly, the present invention relates to a circuit configuration that can reduce the power consumption when driving, at high speed, a display panel such as a plasma display panel, an electro luminescent panel or liquid crystal display (LCD), which is a capacitive load, and a display apparatus to which the drive circuit is applied.

Although the present invention can be applied to any display panel as long as it is a capacitive load, a plasma display (PDP) apparatus is described as an example below.

FIG. 1 is a general block diagram that shows a three-electrode surface discharge AC-driven plasma display panel and FIG. 2 is a sectional view to illustrate the electrode structure of the plasma display panel shown in FIG. 1. In FIG. 1 and FIG. 2, reference number 207 refers to a discharge cell (display cell), 210 refers to a rear glass substrate, 211 and 221 refer to dielectric layers, 212 refers to a phosphor, 213 refers to a rib, 214 refers to address electrodes (A1 to Ad), 220 refers to a front glass substrate, and reference number 222 refers to first electrodes (X electrodes: X1 to XL) or second electrodes (Y electrodes: Y1 to YL). Reference symbol Ca refers to capacitance between neighboring address electrodes, and Cg refers to capacitance between an address electrode and an opposite electrode (X electrode and Y electrode).

A plasma display panel 201 is composed of two glass substrates, that is, the rear glass substrate 210 and the front glass substrate 220, and on the front glass substrate 220, the X electrodes (X1, X2, . . . , XL) and the Y electrodes (scan electrodes: Y1, Y2, . . . , YL) composed as sustain electrodes (including BUS electrodes and transparent electrodes) are arranged.

On the rear glass substrate 210, the address electrodes (A1, A2, . . . , Ad) 214 are arranged so as to be perpendicular to the sustain electrodes (Y electrodes and X electrodes), and each display cell 207, where discharge light emission is caused to occur by these electrodes, is formed in an area where two sustain electrodes, that is, an X electrode and the Y electrode, having the same number (Y1 and X1, Y2 and X2, and so on) that sandwich the area and an address electrode perpendicular to them, intersect.

FIG. 3 is a block diagram that shows the general configuration of a plasma display (PDP) apparatus that uses the plasma display panel shown in FIG. 1, and also shows the main part of a drive circuit for the display panel.

As shown in FIG. 3, a three-electrode surface discharge AC-driven plasma display apparatus comprises a display panel 201, a control circuit 205 that forms a control signal to control the drive circuit of the display panel by using an interface signal input from the outside, an X driver (X electrode drive circuit) 206 that drives panel electrodes by using the control signal from the control circuit 205, a scan electrode drive circuit (scan driver) 203 and a Y common driver 204, and an address electrode drive circuit (address driver) 202.

The X common driver 206 generates sustain discharge (sustain) pulses and the Y common driver 204 also generates sustain pulses, and the scan driver 203 works so that the scan pulse is applied sequentially to each scan electrode (Y1 to YL). In addition, the address driver 202 applies an address voltage pulse corresponding to display data to each address electrode (A1 to Ad).

The control circuit 205 comprises a display data control section 251 that receives a clock CLK and display data DATA and supplies an address control signal to the address driver 202, a scan driver control section 253 that receives a vertical synchronization signal Vsync and a horizontal synchronization signal Hsync and controls the scan driver, and a common driver control section 254 that controls the common drivers (the X common driver 206 and the Y common driver 204). The display data control section 251 comprises a frame memory 252.

FIG. 4 is a diagram that shows examples of the drive waveform of the PDP apparatus shown in FIG. 3, and mainly shows general voltage waveforms to be applied to each electrode during an all-surface-write period (AW), an all-surface-erase period (AE), an address period (ADD) and a sustain period (sustain discharge period: SUS).

In FIG. 4, the drive periods that directly relate to image display are the address period ADD and the sustain period SUS, and it is designed so that image display is achieved at a fixed luminance by selecting pixels to be displayed during the address period ADD and causing the selected pixels to emit light during the subsequent sustain period. In addition, FIG. 4 shows the drive waveforms in each subframe when a frame is composed of a plurality of subframes (subfields).

First, during the address period, after −Vmy, which is an intermediate potential, is applied at a time to the Y electrodes (Y1 to YL), which are the scan electrodes, a scan voltage pulse of −Vy level is sequentially applied instead. In accordance with the application of the scan pulse to each Y electrode, an address voltage pulse of +Va level is applied to each address electrode (A1 to Ad) and pixels on each scan line are selected.

During the next sustain period, a sustain discharge (sustain) pulse of common +Vs level is applied alternately to all of the scan electrodes (Y1 to YL) and the X electrodes (X1 to XL) to cause sustain discharge to occur in the pixels selected previously, and display at a fixed luminance is achieved by means of the successive application. Moreover, it will be possible to achieve a gradated display in density by combining basic actions of these drive waveforms to control the number of times of light emission.

The all-surface-write period AW serves here to maintain the uniformity of the display characteristic by applying a write voltage pulse to all of the display cells in the panel to activate each display cell, and is inserted at certain periods. The all-surface-erase period AE serves to erase the previous display contents before addressing and sustaining for image display are initiated by applying an erase voltage pulse to all of the display cells.

The sustain pulse is applied alternately to every X electrode and Y electrode and the address pulse is applied selectively to an electrode that corresponds to a lit- or unlit-cell. The address pulse has the same period as that of the scan pulse and the period is shorter than that of the sustain pulse.

FIG. 5 is a block circuit diagram that shows an example of an IC used in the PDP apparatus shown in FIG. 3.

For example, when the number of the address electrodes (A1 to Ad) of the display panel is 3,072 and the drive IC to be connected to the address electrodes is assumed to have a 128-bit output, 24 drive IC's are used in total. Generally, these 24 drive IC's are mounted in a plurality of modules so that each module is provided with a plurality of IC's.

FIG. 5 shows the internal circuit configuration of a drive IC chip equipped with the output circuits (234: OUT1 to OUT128) corresponding to 128 bits. Each output circuit 234 comprises a high voltage power supply wire V_{H} and a ground wire GND connected to each other, with push-pull FET's 2341 and 2342 in the final output stage being sandwiched in between. A drive IC 230 further comprises logic circuits 233 to control both FET's, a shift register circuit 231 to select a 128-bit output circuit, and a latch circuit 232.

These control signals consist of a clock signal CLOCK of the shift register 231, data signals DATA1 to DATA4, a latch signal LATCH of the latch circuit 232, and a strobe signal STB for gate circuit control. In FIG. 5, the final output stage has a CMOS configuration (2341, 2342), but a totem pole configuration composed of MOSFET's of the same polarity can be applied.

Next, an example of a method for mounting the above-mentioned drive IC chip is described below. For example, the drive IC chip is mounted on a rigid printed board and the pad terminals for the power supply, signal and output of the drive IC chip and the corresponding terminals on the printed board are connected by wire bonding.

The output wire from the IC chip is connected to the end surface side of the printed board and an output terminal is provided, and the terminal is thermally compress-bonded to a flexible substrate that is provided with a similar terminal to form a module. At the top end of the flexible substrate, a terminal for connection with a panel display electrode is provided and is used after being connected to the panel display electrode by techniques such as a thermal compression bonding or the like.

It is required that power consumption be small for a display, in particular for a PDP apparatus and therefore various techniques to reduce power consumption have been proposed. The drive terminal of each electrode described above is insulated from the circuit ground with respect to the direct current except for the dummy electrode in the panel end portion and, therefore, the capacitive impedance becomes dominant as the load in the drive circuit. As a technique to reduce power consumption of such a capacitive load pulse drive circuit, a power recovery circuit is widely known, which makes use of the resonance phenomena to exchange energy between the capacitive load and an inductance.

U.S. Pat. No. 4,707,692 has disclosed a power recovery circuit in which the energy stored in a capacitor is applied again to a capacitive load by providing an inductor that makes up a resonant circuit together with the capacitive load and by performing on/off control of a switch at ¼ period intervals of the resonance period in an electro-luminescent display apparatus. The energy is transferred between a capacitor 315 and loads 310/312. During the period of charging, the energy in the capacitor is stored in the inductor and half of it charges the loads and the rest returns to the capacitor 315. During the period of discharging, the energy in the loads is once stored in the inductor and then is returned to the capacitor 315.

U.S. Pat. No. 5,081,400 and U.S. Pat. No. 5,828,353 have disclosed a power recovery circuit that is switched at ½ period intervals of the sustain pulse when the sustain pulse is applied in the PDP apparatus.

Japanese Unexamined Patent Publication (Kokai) No. 5-2449916 has disclosed a power recovery circuit used when an address pulse is applied from the address driver in the PDP apparatus.

FIG. 6 shows a conventional low power drive circuit disclosed in Japanese Unexamined Patent Publication (Kokai) No. 2002-175044.

In the conventional case shown in FIG. 6, power consumption is suppressed by driving a power supply terminal 121 of an address drive IC120 using a power recovery circuit 110 equipped with a resonance inductor 112. The power recovery circuit 110 outputs a normal constant address drive voltage at the timing of inducing address discharge to occur at an address electrode of a plasma display panel. Then the voltage of the power supply terminal 121 is lowered to the ground level before the switching states of an output circuit 122 in the address drive IC are switched. At this time, resonance occurs between the resonance inductor 112 in the power recovery circuit 110 and composite load capacitance CL (for example, n×Ca at maximum) of an arbitrary number (for example, n at maximum) of address electrodes driven at a high level, and power consumption of the output device of the output circuit 122 in the address drive IC is suppressed significantly.

In concrete terms, in the conventional driving method in which the power supply voltage of the address drive IC is kept constant, all that corresponds to the amount of change in energy stored in the load capacitance C_{L} before and after switching is consumed in the resistive impedance portion in the charging and discharging current path. Contrary to this, when the power recovery circuit 110 shown in FIG. 6 is used, the amount of potential energy, which is stored in the load capacitor with respect to the reference of the intermediate potential of the address drive voltage, that is, the resonance center of the output voltage, is maintained in the capacitor via the resonance inductor 112 in the power recovery circuit 110. While the power supply voltage is the ground level, switching states of the output circuit are switched and then the power supply voltage of the address drive IC is raised again to a normal and constant drive voltage through resonance, thereby the power consumption can be suppressed.

Moreover, Japanese Unexamined Patent Publication (Kokai) No. 2002-175044 has also disclosed another technique to reduce power consumption for a capacitive load pulse drive circuit that is appropriate to be applied to an address driver and so on. FIG. 7 is a diagram that shows a conventional example of another capacitive load drive circuit disclosed in Japanese Unexamined Patent Publication (Kokai) No. 2002-175044. In this circuit, the power consumption in a drive device 306 in a drive circuit 303 is suppressed by dividing it to a power dividing means 330 composed of resistors, a constant current circuit, and so on. This is based on the principle that the power consumption is divided according to the ratio of divided voltages by guiding the drive current, which originally flows through the drive element 306, to the power dividing means 330 connected in series thereto. Moreover, by raising and lowering a drive power supply 301 in n steps, the input power from the drive power supply 301 to the drive circuit 303 and the power consumption in each part of the drive circuit 303 can be reduced to 1/n. When compared to the power recovery technique described above, it is possible to drive a large load capacitor 305 (C_{L}) at high speed while suppressing the power consumption of the drive element 306 in the drive circuit 303 to the same level, because it is not necessary to induce a resonance phenomenon that gives a high Q, resulting in the advantage that the circuitry cost can be reduced considerably.

In addition, Japanese Unexamined Patent Publication (Kokai) No. 9-62226 has disclosed a configuration that is used to recover the energy discharged from the X electrode to charge the Y electrode, and to recover the energy discharged from the Y electrode to discharge the X electrode, when sustain pulses are applied alternately to the X electrode and Y electrode.

The conventional drive circuit disclosed in U.S. Pat. No. 4,707,692, U.S. Pat. No. 5,081,400, U.S. Pat. No. 5,828,353, Japanese Unexamined Patent Publication (Kokai) No. 5-249916, Japanese Unexamined Patent Publication (Kokai) No. 9-62226, and shown in FIG. 6 is one that reduces the power consumption by utilizing the resonance phenomenon, but there is a problem that the power consumption suppressing effect is considerably lessened as the definition of the plasma display panel becomes higher and the size of its screen becomes larger.

When the output frequency of the drive circuit is increased in accordance with a finer definition, it is necessary to reduce the resonance time described above in order to maintain the control performance of the plasma display panel. If the resonance time is taken as T₀, it is in proportion to the square root of the product of the load capacitance C_{L} and the resonance inductance as shown in a mathematical expression 1 as below

T₀=π\sqrt{LC_{L}}

When the resonance time is reduced, it is necessary to reduce only the value of the resonance inductance provided in the power recovery circuit, therefore, Q value of the resonance decreases and the power suppressing effect is lessened. Moreover, when the parasitic capacitance of the address electrode increases as the screen becomes larger, it is also necessary to reduce the value of the resonance inductance described above in order to suppress the increase in the resonance time described above, therefore, the power suppressing effect is lessened accordingly. In addition, as the output frequency of the drive circuit increases, the power consumption accompanied by the increase in operating frequency of the circuit that drives the plasma display panel using a high voltage pulse also increases and a serious problem of heat generation in the drive circuit (drive IC) occurs. Particularly, because the period of the address pulse is shorter than the period of the sustain pulse, there is a problem that it is difficult to apply the method for reducing power consumption, which has been disclosed in the above-mentioned publicly known cases, to an address driver.

Moreover, the sustain pulse is applied to all of the sustain electrodes and the capacitive load is constant. Contrary to this, as the address pulse is applied to each load electrode independently of each other according to the display video, the load capacitance to be driven changes considerably. For example, when the number of load capacitances that change their states for each display line is large, the power consumption becomes large and the configuration disclosed in Japanese Unexamined Patent Publication (Kokai) No. 5-2449916 can be used to reduce the power consumption, but when the same image continues in the vertical direction and the state of each load capacitance does not change, a problem occurs that the power consumption becomes large if the configuration disclosed in Japanese Unexamined Patent Publication (Kokai) No. 5-2449916 is used.

In the capacitive load drive circuit that uses the power dividing method shown in FIG. 7, it is also possible to suppress heat generation in all the system, including the power supply circuit, and further reduce the cost, if the input power from the drive power supply 301 to the drive circuit 303 can be further decreased.

If the power consumption in the drive circuit 303 cannot be suppressed sufficiently, the cost relating to heat dissipation in each part of the display and the cost of parts are raised. Moreover, there is possibility that the light emission luminance is suppressed by the limit of heat dissipation of the display apparatus itself, or the characteristic of the flat panel display of being able to be made thinner and lighter is not utilized fully.

### SUMMARY OF THE INVENTION

The object of the present invention is to provide a capacitive load drive circuit able to not only suppress the power consumption (heat generation) but also suppress the increase in cost of each part of the display even when the drive circuit is sped up, and to provide a display apparatus such as a PDP apparatus using the same.

In order to achieve the above-mentioned object, a capacitive load drive power supply circuit according to a first aspect of the present invention is characterized by the use of a transformer.

In concrete terms, in the capacitive load drive power supply circuit according to the first aspect of the present invention, each one end of the primary coil and the secondary coil of a transformer is connected to an output terminal to be connected to a capacitive load, a first switch circuit is connected between the other end of the primary coil and a first reference potential, a second switch circuit is connected between the other end of the secondary coil and a second reference potential, and a power supply switch circuit is connected between the output terminal and a drive power supply.

By connecting a drive load and the primary coil of the transformer using the first switch circuit, resonance is caused to occur between the capacitance of the drive load and the exciting inductance of the primary coil of the transformer. Due to this resonance, the electrostatic energy stored in the capacitance of the drive load can be efficiently converted into the electromagnetic energy in the exciting inductance of the primary coil of the transformer and stored. Due to this, all the electrostatic energy is converted into the electromagnetic energy in a short time such as a quarter of the resonance period and both ends of the primary coil become almost equal to the first reference potential. In other words, the potential of the drive load becomes equal to the first reference potential. Then, the above-mentioned electromagnetic energy can be taken out from the secondary coil of the transformer by cutting off the first switch circuit at a timing proper to the drive. The power consumption in the drive circuit can be minimized by properly selecting a circuit section (drive load) into which the electromagnetic energy is to be directed for reuse, and by properly designing the exciting inductance of the secondary coil. The energy loss during the energy re-entry is compensated for by the drive power supply via the power supply switch circuit. As described above, according to the first aspect, it is possible to realize a low-cost capacitive load drive power supply circuit, in which the number of semiconductor switch circuits is reduced by the current switching using a cheap transformer, that is, a passive device.

As a modification of the first aspect, it is possible to connect the terminal, which is to be connected to the output terminal of the secondary coil of the transformer, to the path to which the power supply switch circuit is connected.

It is desirable that a third switch circuit composed of a one-way conductive element is further provided between the output terminal and the first reference potential.

The second switch circuit can be composed of the one-way conductive element.

It is also possible to make the first reference potential equal to the second reference potential.

It is also possible to connect a fourth switch circuit between the connection point of the primary coil and the first switch circuit, and a fifth reference potential, and the fifth reference potential is, for example, an output terminal of the drive power supply, and the fourth switch circuit can be composed of the one-way conductive element.

Moreover, if an impedance circuit is connected to the path to which the power supply switch circuit is connected, the power consumption can be divided.

A capacitive load drive power supply circuit according to a second aspect of the present invention is characterized in that it uses an inductance element but not a capacitor.

In concrete terms, a first switch circuit, a coil and a second switch circuit are connected in series between the output terminal to be connected to a capacitive load and a first reference potential, a third switch circuit is connected between the connection point of the first switch circuit and the coil, and the first reference potential, a fourth switch circuit is connected between the connection point of the coil and the second switch circuit, and the output terminal, and the power supply switch circuit is connected between the output terminal and the drive power supply.

According to the second aspect of the present invention, resonance is caused to occur between the capacitance of the drive load and the exciting inductance of the coil by connecting the drive load to the first reference potential via the coil and the first and second switch circuits. By bringing the second switch circuit and the third switch circuit into conduction so that both ends of the coil become equal in potential, the electrostatic energy of the capacitance of the drive load converted into the electromagnetic energy of the coil is stored in the coil in a short time such as a quarter of the resonance period. When the first and second switch circuits enter the shut-off state, the energy returns from the other terminal of the coil toward the drive load via the third and fourth switch circuits. The energy loss during the process of reusing the above-mentioned energy is compensated for from the drive power supply via the power supply switch circuit. By using inexpensive coils and reducing the number of semiconductor switch circuits, it is possible to realize a high-speed drive, low power consumption and low-cost capacitive load drive power supply.

The third switch circuit and the fourth switch circuit can be composed of the one-way conductive elements.

Moreover, it is desirable that an impedance circuit is connected to the path to which the power supply switch circuit is connected.

The capacitive load drive power supply circuit described above is proper for use as a power supply circuit for a capacitive load drive circuit such as an address driver in a PDP apparatus.

A capacitive load drive circuit comprises a capacitive load, a first drive power supply, a second drive power supply, and first and second drive elements that are connected in series between the first drive power supply and the second drive power supply and, the connection point of which is connected to the capacitive load, and the capacitive load drive power supply circuit described above is used for either of the first or the second drive power supply.

In the case of an address driver in a PDP apparatus, there are a plurality of capacitive loads and a plurality of pairs of first and second drive elements for driving the plurality of capacitive loads, respectively, but first and second drive power supplies are connected commonly to the plurality of pairs of the first and second drive elements. The plurality of capacitive loads are set to the individual potential states independent of each another but, when the potential state is set, all the plurality of capacitive loads are connected to the capacitive load drive power supply circuit and the stored electrostatic energy is once recovered to the capacitive load drive power supply circuit to be stored as electromagnetic energy, and then all of the drive elements are changed to the first potential. According to the potential to be set next, one of the first and second drive elements is brought into a conductive state, and the output terminal of the drive power supply is changed to the second potential by discharging the electromagnetic energy stored in the capacitive load drive power supply circuit, and the corresponding capacitive load is changed to the second potential through the first or second drive element.

As described above, in the case of the address driver or the like in the PDP apparatus, the power consumption increases when the number of load capacitances that change for each display line is large, and the power consumption can be reduced by performing the above-mentioned power recovery function of the capacitive load drive power supply circuit, but when the state of each load capacitance does not change, the power consumption is small and the power consumption can be reduced, on the contrary, by not performing the power recovery function.

Therefore, in a capacitive load drive circuit according to a third aspect of the present invention, whether the power recovery function of the capacitive load drive power supply circuit is performed is controlled in accordance with the state of change of each capacitive load.

In concrete terms, a current detection circuit that detects the current flowing out from the drive power supply is provided to the path to which the power supply switch circuit of the capacitive load drive power supply circuit is connected, and whether the power recovery function of the capacitive load drive power supply circuit is performed is controlled in accordance with the detection result.

In another method, an expected value of the power consumption in the drive circuit is calculated from the information about the changes in each drive state of the plurality of capacitive loads and whether the power recovery function of the capacitive load drive power supply circuit is performed is controlled.

In still another method, there is provided a temperature detection circuit that detects the temperature of a part of the capacitive load drive circuit such as an address driver and whether the power recovery function of the capacitive load drive power supply circuit is performed is controlled in accordance with the detected temperature.

In a capacitive load drive circuit according to a fourth aspect of the present invention, the energy used to release the sustain pulse applied to the X electrode in a PDP apparatus is recovered and is reused to apply the sustain pulse to the Y electrode immediately after, and moreover, the energy used to release the sustain pulse applied to the Y electrode is recovered and is reused to apply the sustain pulse to the X electrode immediately after, and this cycle is repeated.

In a conventional power recovery circuit of the sustain pulse, the energy of the sustain pulse to be applied to both X electrode and Y electrode is recovered by the X common drive circuit and the Y common drive circuit and is once stored in the capacitor, then the energy of the sustain pulse recovered from the X electrode to the capacitor is reused to apply the sustain pulse to the X electrode next time, and the energy of the sustain pulse recovered from the Y electrode is reused to apply the sustain pulse to the Y electrode next time. Moreover, the above-mentioned Japanese Unexamined Patent Publication (Kokai) No. 9-62226 has disclosed a configuration in which the power recovery circuit is provided between the X common drive circuit and the Y common drive circuit, and the energy of the sustain pulse applied to the X electrode is recovered and once stored in the capacitor and the energy thus stored in the capacitor is used for the application of the sustain pulse to be applied to the Y electrode immediately after, and similarly the energy of the sustain pulse applied to the Y electrode is recovered and once stored in the capacitor and the energy thus stored in the capacitor is used for the application of the sustain pulse to be applied to the X electrode immediately after. In other words, the recovered energy is once stored in the capacitor in either case, and then the energy stored in the capacitor is taken out and used for application of the sustain pulse.

Contrary to this, in the capacitive load drive circuit according to the fourth aspect of the present invention, a capacitor to which energy is temporarily stored is not used but only an inductance element (coil circuit) is used, and the energy used when the voltage applied to one of two electrodes forming the drive load is released is recovered and is reused to apply a voltage to the other electrode immediately after. In this manner, the recovery efficiency is no longer dependent on the period of the sustain pulse and a sustain pulse of a high frequency can be handled.

### BRIEF DESCRIPTION OF THE DRAWINGS

The features and advantages of the invention will be more clearly understood from the following description taken in conjunction with the accompanying drawings, wherein:

FIG. 1 is a general block diagram that shows a three-electrode surface discharge AC-driven plasma display panel.

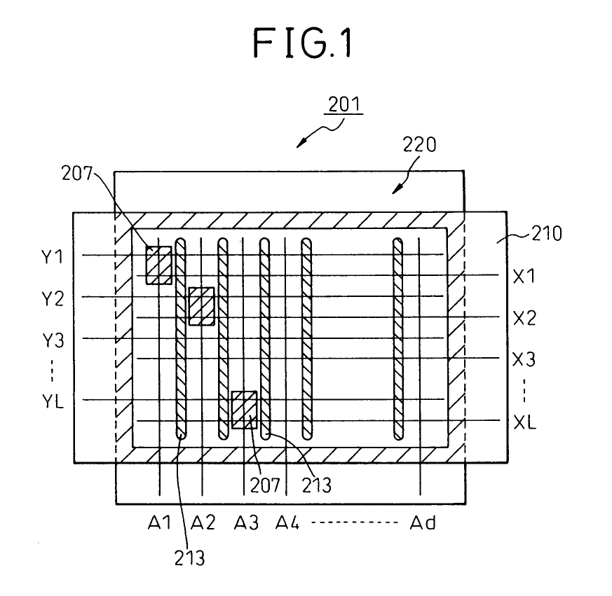

FIG. 2 is a sectional view that illustrates the electrode structure of the plasma display panel shown in FIG. 1.

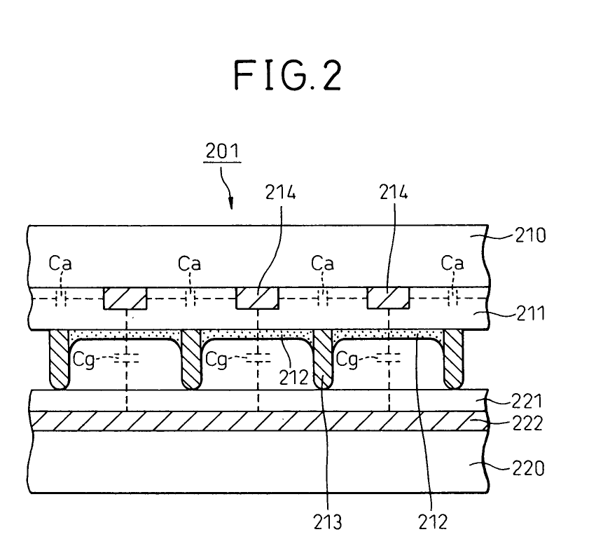

FIG. 3 is a block diagram that shows the entire configuration of a plasma display apparatus using the plasma display panel shown in FIG. 1.

FIG. 4 is a diagram that shows an example of drive waveforms in the plasma display apparatus shown in FIG. 1.

FIG. 5 is a block circuitry diagram that shows an example of an IC used in the plasma display apparatus shown in FIG. 3.

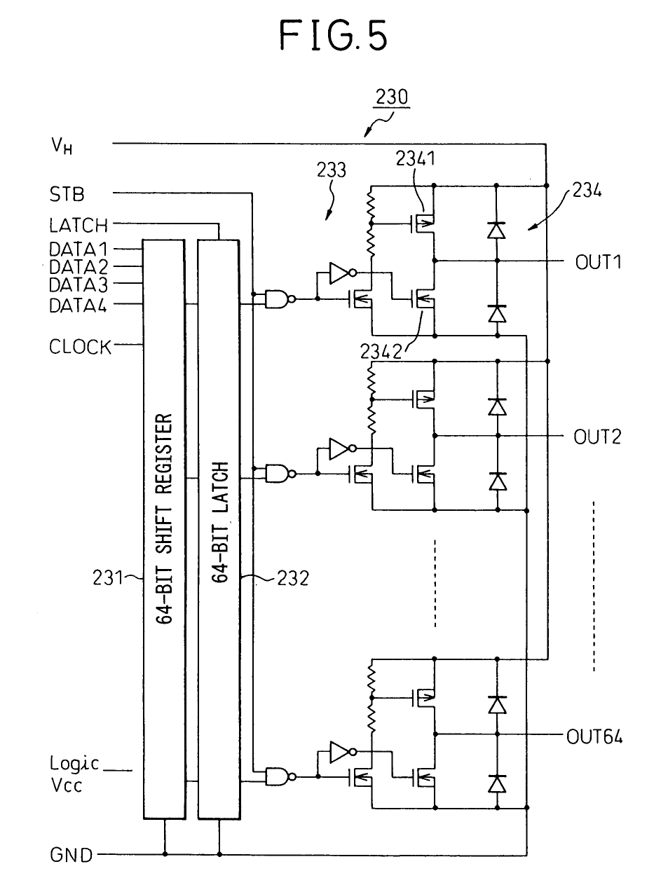

FIG. 6 is a block diagram that shows an example of a drive circuit of a conventional plasma display panel using a power recovery method.

FIG. 7 is a block diagram that shows another example of a drive circuit of a conventional plasma display panel.

FIG. 8 is a block diagram that shows the configuration of a capacitive load drive circuit in a first embodiment of the present invention.

FIG. 9 is a block diagram that shows the entire configuration of a PDP apparatus in a second embodiment of the present invention.

FIG. 10 is a diagram that shows the configuration of an address driver in the second embodiment.

FIG. 11 is a diagram that shows the configuration of an address driver power recovery power supply in the second embodiment.

FIG. 12 is a time chart that shows the action of the address driver power recovery power supply in the second embodiment.

FIG. 13 is a diagram that shows the configuration of an address driver power recovery power supply in a PDP apparatus in a third embodiment of the present invention.

FIG. 14 is a diagram that shows the configuration of an address driver power recovery power supply in a PDP apparatus in a fourth embodiment of the present invention.

FIG. 15 is a block diagram that shows the configuration of a capacitive load drive circuit in a fifth embodiment of the present invention.

FIG. 16 is a time chart that shows the action of the capacitive load drive circuit in the fifth embodiment.

FIG. 17 is a diagram that shows the configuration of an address driver power recovery power supply in a PDP apparatus in a sixth embodiment of the present invention.

FIG. 18 is a diagram that shows an example of configuration of a current detection circuit.

FIG. 19 is a diagram that shows the configuration of an address driver power recovery power supply in a PDP apparatus in a seventh embodiment of the present invention.

FIG. 20 is a block diagram that shows the configuration of a PDP apparatus in an eighth embodiment of the present invention.

FIG. 21 is a diagram that shows the configuration of an address driver power recovery power supply in a PDP apparatus in a ninth embodiment of the present invention.

FIG. 22 is a diagram that shows the configuration of a common driver in a PDP apparatus in a tenth embodiment of the present invention.

FIG. 23 is a time chart that shows the action of a common driver in the PDP apparatus in the tenth embodiment.

FIG. 24 is a diagram that shows the configuration of a common driver in a PDP apparatus in an eleventh embodiment of the present invention.

FIG. 25 is a time chart that shows the action of the common drive in the PDP apparatus in the eleventh embodiment.

### DESCRIPTION OF THE PREFERRED EMBODIMENTS

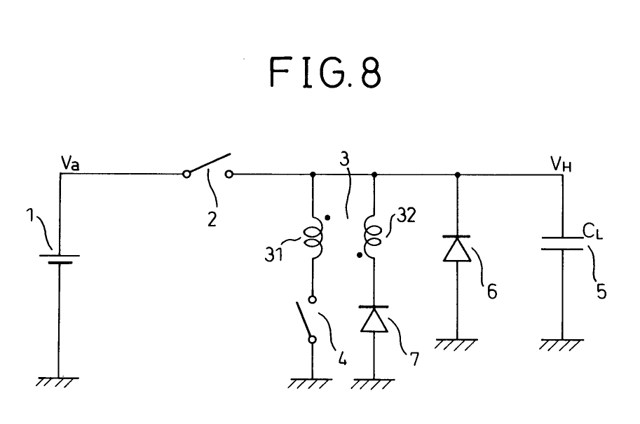

FIG. 8 shows the configuration of the display drive circuit in the first embodiment of the present invention. In FIG. 8, reference number 5 denotes a capacitive load that represents the drive terminal of a display. The capacitance of the drive load is assumed to be C_{L}, and the applied voltage, V_{H}. A drive power supply 1 supplies a voltage Va to the drive load. When the applied voltage V_{H} to the drive load 5 is raised or lowered, a power supply switch circuit 2 is once brought into the OFF-state (open state). When the applied voltage is lowered, a first switch circuit 4 is brought into the ON-state (conductive state), and the electrostatic energy stored in C_{L} is converted into the electromagnetic energy in a primary coil 31 by causing resonance to occur between the load capacitance C_{L} and the primary coil 31 of a transformer 3. As a secondary coil 32 is wound in the direction shown schematically, during resonance, an electromotive force is produced in the direction such that the cathode side of a diode 7 is high potential. Due to this, the diode 7 is shut off and no current flows through the secondary coil 32, the resonance is under the control of the characteristic of the primary coil. In a quarter of the resonance period, the applied voltage V_{H} drops to 0V, and a diode 6 is brought into conduction and the voltage between the terminals of the primary coil becomes nearly equal to 0V. If the voltage V_{H} drops to 0V, the diode 6 is not necessary. At this time, almost all the electrostatic energy stored in C_{L} is converted into the electromagnetic energy of the primary coil 31. When the switch circuit 4 is switched to the OFF-state from this state, the current in the primary coil 31 decreases in magnitude, and at the same time, because an electromotive force is induced in the secondary coil 32 in the direction such that the diode 7 is brought into conduction, the stored electromagnetic energy is discharged from the secondary coil 32. By recharging the load capacitance C_{L} using the current in the secondary coil at this time, the applied voltage V_{H} is raised. In the process in which the applied voltage is raised and lowered, the energy loss due to the connection loss of resistive components and transformers in each part of the circuit is compensated for, from the drive power supply 1, by switching the switch circuit 2 into the ON-state. In FIG. 8, it does not matter if the primary coil 31 of the transformer 31 and the switch circuit 4 change their connected positions. Moreover it is possible to replace the diodes 6 and 7 with switch elements controlled from the outside, respectively, such as a MOSFET and IGBT. In this case, it is also possible to change the positional relation between the secondary coil 32 and the switch element corresponding to the diode 7. The present invention can be applied to an electro-luminescent display, a liquid crystal display, or a CRT display, in addition to a plasma display, as long as the drive load can be regarded as a capacitive load. When the load capacitance C_{L} is recharged, it cannot be charged to a voltage Va only by the resonance energy because of the loss of resonance energy, therefore, the switch circuit 2 is brought into conduction immediately before or after the completion of recharging so that it is charged to the voltage Va.

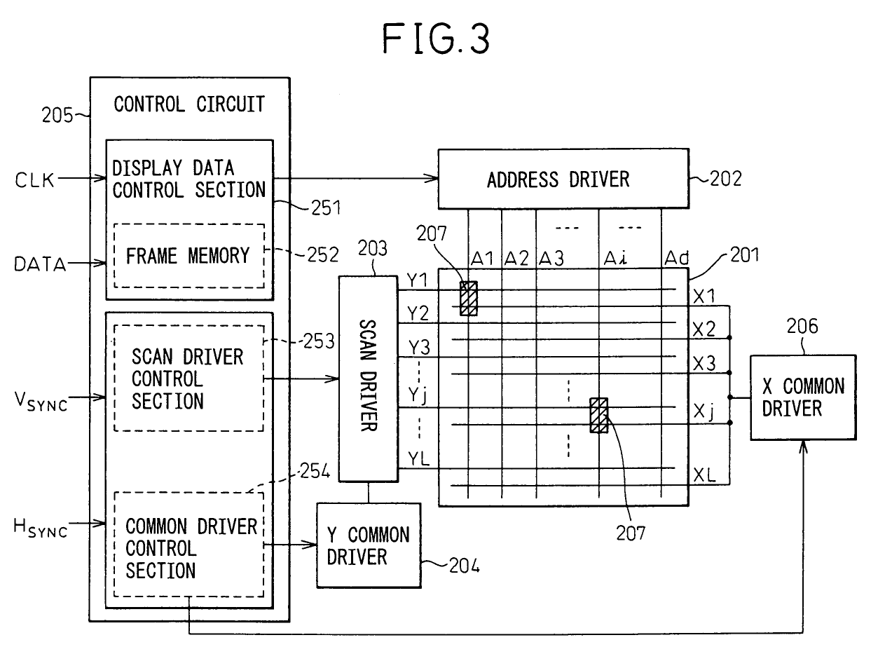

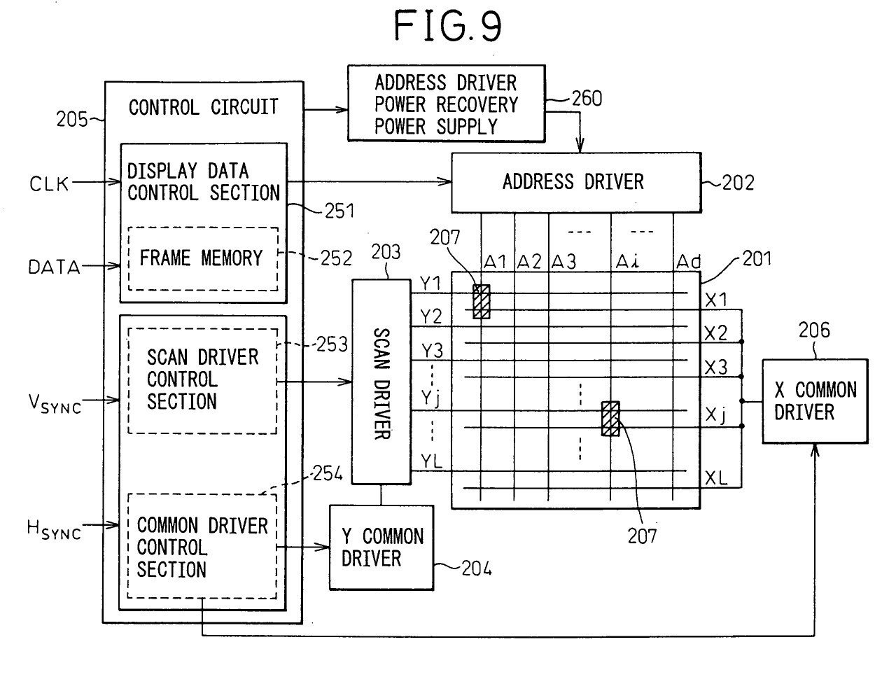

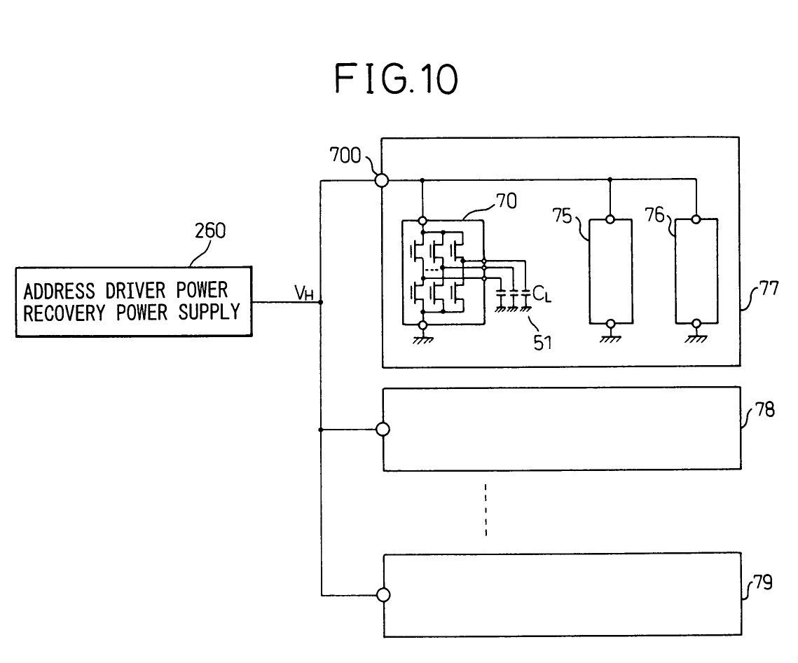

FIG. 9 is a diagram that shows the general configuration of the PDP apparatus in the second embodiment of the present invention and FIG. 10 is a diagram that shows the power supply of an address driver. As obvious by comparison between FIG. 9 and FIG. 3, the PDP apparatus in the second embodiment differs from the conventional PDP apparatus in that an address driver power recovery power supply 260 is provided. In the conventional PDP apparatus, the power supply of the address driver 202 is one that supplies only voltage Va and ground GND. Contrary to this, the PDP apparatus in the second embodiment once recovers and reuses the power retained by the address electrode, when the address driver power recovery power supply 260 supplies the voltage Va to the high-potential power terminal of the address driver 202.

The address electrodes in the plasma display panel are drive loads 51 each having a capacitance C_{L}, and drive IC's 70, 75 and 76 that drive these are mounted in drive modules 77 to 79 in plural units to improve their mountability and heat radiating performance. The address driver power recovery power supply 260 supplies the voltage Va that is applied commonly to the drive IC's within these drive modules. V_{H} denotes the voltage at a terminal 700. The ground voltage GND to be applied commonly to the drive IC's in the drive modules is supplied similarly as before. Due to this, the power consumption of all the drive IC's can be reduced.

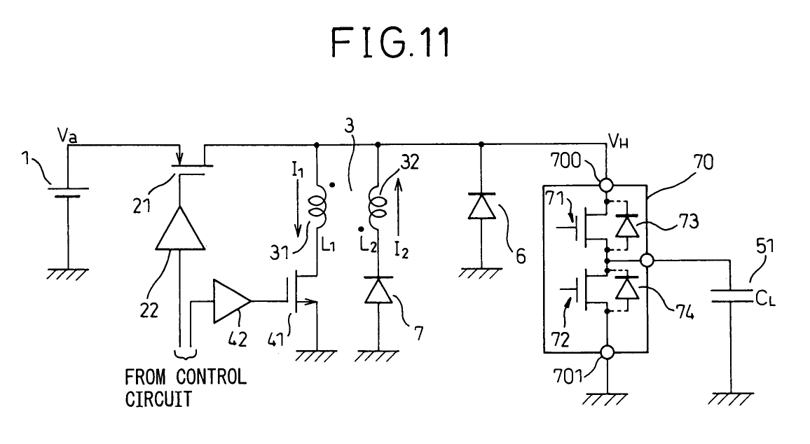

FIG. 11 is a diagram that shows the configuration of the address driver power recovery power supply 260 in the second embodiment, and only a pair of drive devices of the drive IC 70 are shown here. As shown schematically, the address driver power recovery power supply 260 in the second embodiment is composed of the capacitive load drive circuit in the first embodiment.

In FIG. 11, the drive IC 70 directly drives the drive load 51 and the voltage Va is supplied to the high-potential power terminal 700 of the drive IC 70 from the address driver power supply recovery power supply 260. In the drive IC 70, a high-side MOSFET 71 and a low-side MOSFET 72 are integrated and these MOSFET's are parasitized by diodes 73 and 74, respectively. MOSFET's 21 and 41 are used as the switch circuits 2 and 4, respectively, in the first embodiment shown in FIG. 8, and these MOSFET's are driven by buffer circuits 22 and 42, and the control signal is supplied from the control circuit 205. MOSFET's and diodes are used here in each switch circuit, but it is needless to say that these can be replaced with proper semiconductor devices or switch devices such as IGBT's and bipolar transistors. As the transformer 3, an air-core transformer, the coupling coefficient of which has been improved by techniques such as the bifilar winding, the sandwich winding, and the space winding, can be applied. Moreover, if the high frequency characteristic and the magnetic saturation characteristic are taken into consideration, a transformer can be used, the coupling coefficient of which has been improved, the characteristic of which has been stabilized, and the size of which has been reduced, by using general core materials such as a ferrite and a dielectric material. The winding can be a single wire, but a stranded wire or a parallel winding or a series winding are recommended, if the skin effect or the proximity effect is aimed at within the limit of the transformer in size and cost.

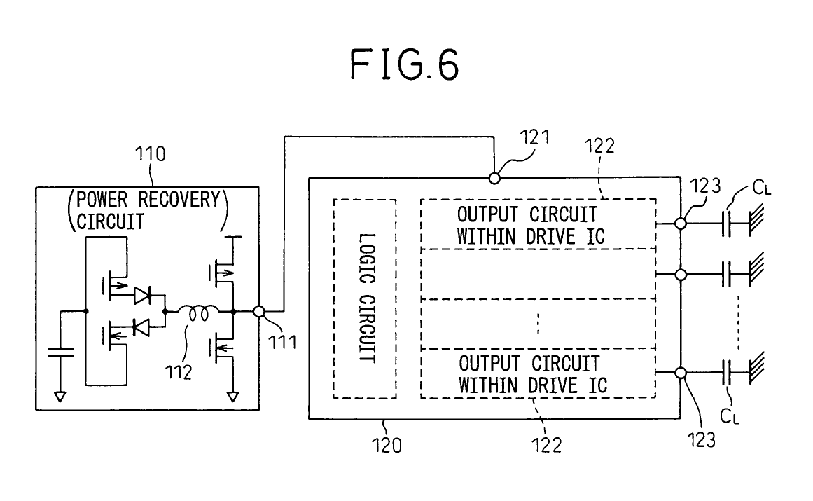

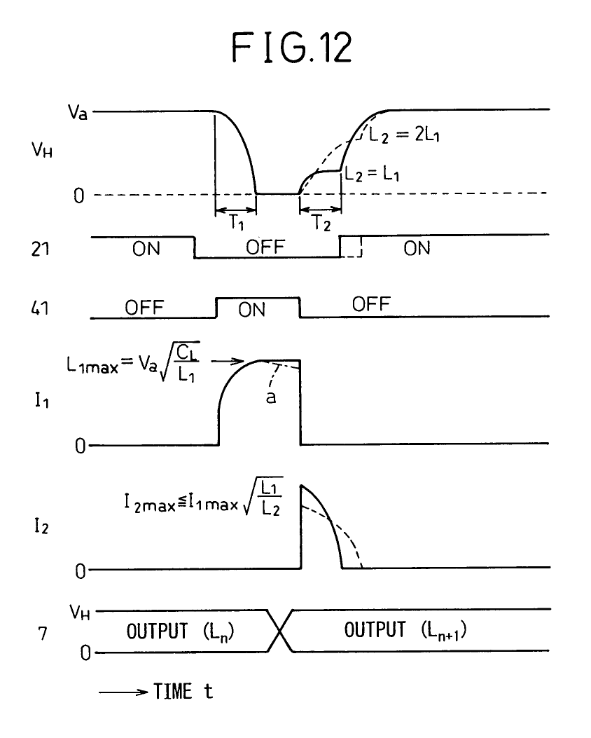

The operations of the display drive circuit in the second embodiment shown in FIG. 11 are described in detail using the waveform diagram shown in FIG. 12. In FIG. 12, the power supply terminal voltage V_{H} of the drive IC, the states of the MOSFET's 21 and 41, the current I₁ of the primary coil and the current I₂ of the secondary coil of the transformer 3, and the state of the drive IC 70 are shown in this order from top to bottom as time elapses. In the case where the conventional power supply circuit is used, when the output state of the drive IC 70 switched from output (Lₙ) to output (Lₙ₊₁), a part or the whole of the transferred energy accompanying the raise and drop of the voltage of the drive load 51 is consumed by internal devices 71 and 72 within the IC. In order to reduce this power consumption, in the second embodiment, the electrostatic energy stored in the drive load 51 is taken out from the power supply terminal 700 of the drive IC 70 to the primary coil 31 of the transformer 3. For this purpose, after the MOSFET 21 is turned OFF first, the MOSFET 41 is turned ON. At this time, the current I₁ in the primary coil 31 increases to Va (C_{L}/L₁)^{1/2} in a sinusoidal manner. The time T1 is π(C_{L}/L₁)^{1/2} as shown in the mathematical expression 2, that is, it is halved compared to the conventional drive method shown in FIG. 6, therefore, a high-speed drive can be realized.

T₁−π\sqrt{LᵢC_{L}}/2

T₂=π\sqrt{L₂C_{L}}/2

T₃=π\sqrt{L₃C_{L}}/2

At this time, as the current is taken out from the power supply terminal 700 of the drive IC 70 via the parasitic diode 73 of the high-side MOSFET 71, only by prohibiting the low-side MOSFET 72 from switching from the OFF-state to the ON-state, it is possible to switch the states of the high-side MOSFET 71 and the low-side MOSFET 72 to speed up the circuit operation. As the diode 6 is brought into conduction when the power supply voltage V_{H} of the drive IC drops from Va to 0V, the voltage between the terminals of the primary coil 31 becomes nearly equal to 0V, the current I₁ is kept at Va (C_{L}/L₁)^{1/2} and, therefore, the electromagnetic energy is conserved. For reduction in cost, it is also possible to eliminate the diode 6 and utilize the conductive states of the parasitic diodes 73 and 74 within the drive IC 70. However, when the diode 6 is eliminated, there may be a case where the decrease in the current I₁, denoted by the alternating long and short dashed line a in the waveform of I₁, cannot be ignored. Therefore, when the conduction period of the MOSFET 41 is extended, the energy loss should be taken into consideration. Then, after the output state of the drive IC 70 switches to output (Lₙ₊₁), the MOSFET 41 is turned OFF. Even in the case where it takes long time to switch the output state completely, if only the ON-state of the high-side MOSFET 71 within the drive IC 70 is fixed, the MOSFET 41 can be turned OFF. The very instance that the current I₁ of the primary coil 31 decreases because the MOSFET 41 is turned OFF, an electromotive force is produced in the secondary coil 32 in the direction such that the diode 7 is brought into conduction, and the current I₂ flows while describing a sinusoidal waveform as shown schematically. The maximum value of the current I₂ is the maximum value (L₁/L₂)^{1/2} of the current I₁, but it decreases as the coupling coefficient between the primary and secondary coils decreases. In addition, it is possible to freely set the time, which is required for reproducing the electrostatic energy in the drive load with the help of the resonance between the secondary coil and the load capacitance, by correctly designing L₂. The resonance time T₂ of the secondary coil is π(L₂/C_{L})^{1/2} as shown in the mathematical expression 1, that is, it is halved compared to the conventional method. Moreover, in the circuits shown in FIG. 8 and FIG. 11, the diode 6 is connected to the ground but it can be connected to a potential point other than the ground potential in order to, for example, speed up the power reproduction in the drive load 5 or reduce the power supplied from the drive power supply 1.

For example, the solid lines denote the waveforms of V_{H} and I₂ when L₁ and L₂ are designed so as to be equal to each other. In the current path of the resonance current flowing into the primary coil 31, the conductive resistance of the parasitic diode 73 is the factor of the power loss. In the current path of the resonance current flowing out of the secondary coil 32, the ON-state resistance of the high-side MOSFET 71, the conductive resistance of which is generally higher than that of the parasitic diode 73, is the factor of the power loss. Because of these power losses, the electrostatic energy to be reproduced in the load capacitance decreases and, therefore, the power supply terminal voltage V_{H} after the resonance time T₂ becomes lower than the drive power supply voltage Va. The power loss is compensated for from the drive power supply 1 by bringing the MOSFET 21 into the ON-state after the resonance time T₂ elapses. As a technique to reduce these power losses, there can be used one that reduces the effective value of the resonance current by increasing the exciting inductance L₂ of the secondary coil. By reducing the effective value of the resonance current, the power loss caused by the resistance described above can be reduced. If the drive voltage of the load capacitance is constant, the average current corresponding to the amount of charge for charging is also constant, but the effective value of the current becomes smaller for the lower peak values of the current, because it is in proportion to the average value of the current squared. As the exciting inductance L₂ of the secondary coil increases, the resonance time also increases, but it is possible to reduce the peak value of the resonance current and the effective value. For example, when it is designed so that the value of L₂ is twice as large as L₁, the reproduced energy in the load capacitance increases as shown by the broken line waveform of the power supply terminal voltage V_{H}. In order to increase the reproduced energy to the maximum, it is desirable to extend the period of the OFF-state of the MOSFET 21 also in accordance with the resonance time as shown by the broken line. However, when priority is given to a high-speed drive, it is possible to bring the MOSFET 21 into the ON-state earlier during resonance as shown by the solid line. In this case also, the power loss can be reduced compared to the case where the L₁ is equal to L₂. On the contrary, when it is intended that the above-mentioned power reproduction should be performed at high speed even though the power loss increases, more or less, the inductance L₂ can be made smaller than the inductance L₁.

Although the power supply having the power recovery function is used as the power supply on the high-potential side of the drive IC in the second embodiment, it is also possible to provide the power supply on the low-potential side with the power recovery function. In FIG. 11, for example, the high-potential power terminal 700 of the drive IC 70 is connected to the ground potential, and the low-potential power terminal 701 is connected to the output terminal of the address driver power recovery power supply described above, not to the ground point. In this case, it is needless to say that the drive power supply 1 and the semiconductor devices such as the MOSFET's 21 and 41, and the diodes 6 and 7 in the circuit of the address driver power recovery power supply reverse their polarity. It is also needless to say that level shift has to be performed on the control signal via circuits such as the photocoupler circuit or the condenser coupling circuit when the drive IC 70 is a type that inputs the control signal with respect to the reference of the potential of the low-potential power terminal 701 and the control signal is input with respect to the reference of the ground potential. Similarly, if the voltage between Va/2 and −Va/2 is applied to the drive load 51, it is possible to connect the address driver power recovery power supply equipped with the drive power supply 1 that gives the reference potential of Va/2 to the high-potential power terminal 700 of the drive IC 70, and connect the potential reference point of −Va/2 to the low-potential power terminal 701. Or, it is also possible to connect the potential reference point of Va/2 to the high-potential power terminal 700 of the drive IC 70 and connect the address driver power recovery power supply equipped with the drive power supply 1 that gives the reference potential of −Va/2 to the low-potential power terminal 701.

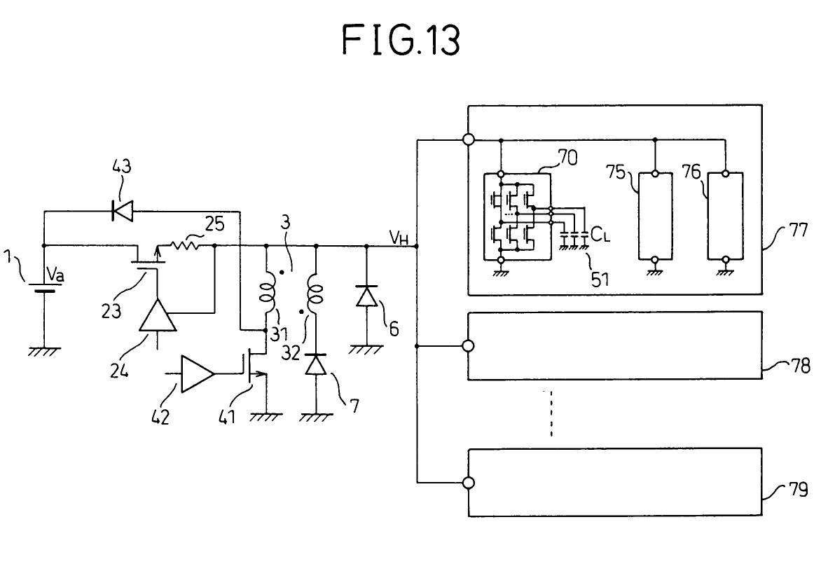

FIG. 13 is a diagram that shows the configuration of the address driver power recovery power supply in the PDP apparatus in the third embodiment of the present invention. The address driver power recovery power supply in the third embodiment differs from the power supply in the second embodiment in that the connection point between the primary coil 31 and the first switch circuit 41 is connected to the terminal of the power supply 1 via a diode 43.

In the circuit shown in FIG. 13, a counter-electromotive force, produced in the primary coil 31 when the MOSFET 41 is shut off, is suppressed to the voltage Va of the drive power supply 1 via the diode 43. By this, it is possible to use an inexpensive device with low withstand voltage instead of the MOSFET 41. Moreover, in order to suppress a malfunction of the switch circuit caused by a small variation in voltage induced in the power line impedance by the surge current that flows through the diode when the counter-electromotive force is suppressed, an N-channel MOSFET 23, the input terminal of which has been arranged away from the drive power supply, is used. The gate of the N-channel MOSFET 23 is driven by a buffer circuit 23 with respect to the reference of the source potential. An integrated circuit driven by a floating power supply capacitor connected to the source potential of the MOSFET 23 can be used instead of the buffer circuit 24. A pulse transformer connected between the source and the drain of the MOSFET 23 can also be used. Moreover, it is possible to suppress the counter-electromotive force produced in the primary coil 31 by connecting the cathode terminal of the diode 43 to another potential point and not to the drive power supply 1.

If it is intended that the cost should be reduced by driving as many drive terminals of the plasma display panel as possible using one drive circuit, the power consumption of the drive IC increases because of the drive current that increases as the load capacitance increases. Therefore, in order to further reduce the power consumption of the drive IC, a constant current source switch circuit is used as the switch circuit 2 shown in FIG. 8. If the switch circuit 2 is operated as a constant current source in the ON-state, it is possible to suppress the effective value of the drive current that flows through the drive IC and the power consumption to a low level. In concrete terms, current feedback is performed on the drive device used in the switch circuit. For example, a feedback resistor 25 is connected in series to the source of the MOSFET 23 shown in FIG. 13 and the drive voltage from the buffer circuit 24 is applied between the feedback resistor 25 and the gate of the MOSFET 23. In the circuit shown in FIG. 8, it is also possible to obtain an operation equivalent to that of the constant current source obtained from the above-mentioned MOSFET 23 and the resistor 25, because the conductive impedance of the switch circuit 2 in the ON-state is raised by inserting impedances (circuits) such as a resistor and a constant current circuit in series with the switch circuit 2.

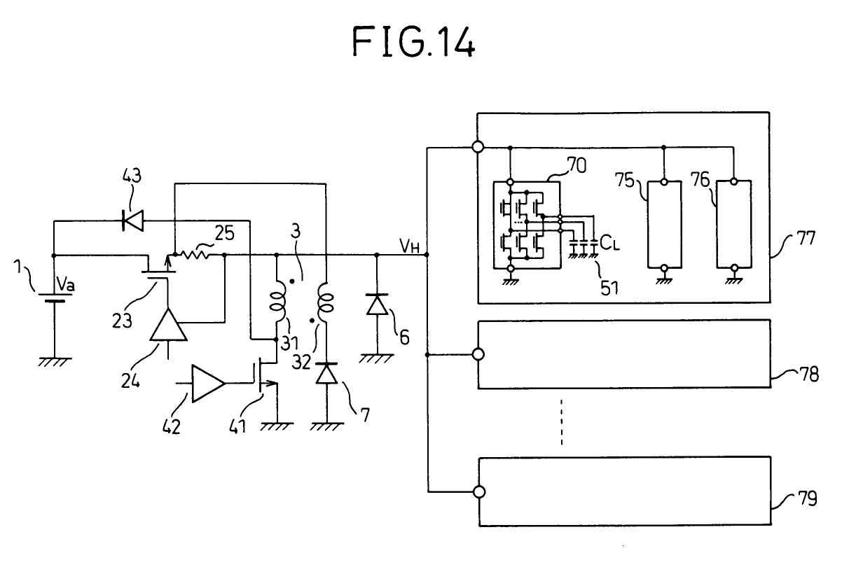

FIG. 14 is a diagram that shows the configuration of the address driver power recovery power supply in the PDP apparatus in the fourth embodiment of the present invention. The display drive circuit in the fourth embodiment differs from that in the third embodiment in that the secondary coil 32 of the transformer 3 is connected to the source terminal of the MOSFET 23 that operates as a constant current source while it is in the ON-state. Due to this, the drive current toward the drive modules 77 to 79 including the drive IC70 is always made to be a constant current at the rise of the applied voltage V_{H}, and the effective value is minimized. The charges to be supplied from the drive power supply 1 are reduced by the amount corresponding to the amount of charges supplied from the secondary coil 32, and the power consumption of the whole of the drive circuit can be reduced. Therefore, even in a case where a large load capacitance such as that when a matrix electrode of the plasma display panel is driven, the cost for heat dissipation of the drive module 77, and so on, can be suppressed.

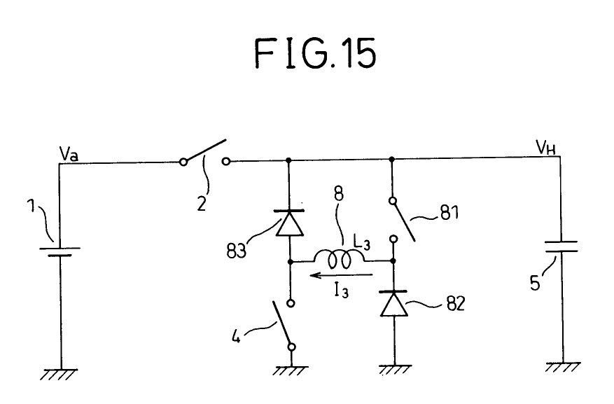

FIG. 15 is a diagram that shows the configuration of the capacitive load drive circuit in the fifth embodiment of the present invention. In the capacitive load drive circuit in the fifth embodiment, a low power circuit equivalent to the drive circuit shown in FIG. 8 can be realized by using an inexpensive coil 8 instead of a transformer. The capacitive load drive circuit in the fifth embodiment is also suitable for use as a power supply of an address driver in a PDP apparatus.

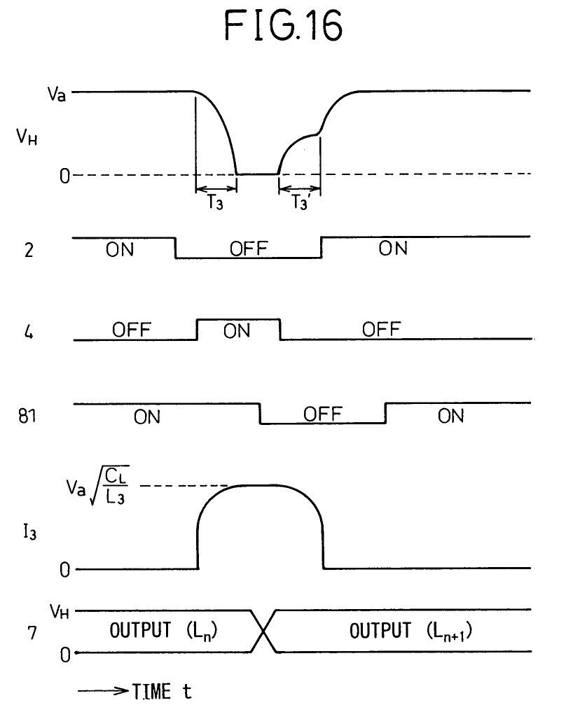

The operation of the circuit is described by reference to FIG. 16. In FIG. 16, the applied voltage V_{H} to the drive load 5, the states of the switch circuits 2 and 4 and a switch circuit 81, and the current I₃ of the coil 8 are shown in this order from top to bottom. As shown in FIG. 11, the output state of the drive IC 70 when the drive load 5 is driven via the drive IC 70 is also shown in brackets. The electrostatic energy stored in the drive load 5 is taken out into the coil 8 to reduce the power consumption by bringing the switch circuits 81 and 4 into the ON-state. For this purpose, first the switch circuit 81 is brought into the ON-state and after the switch circuit is brought into the OFF-state, the switch circuit 4 is brought into the ON-state. At this time, the current I₃ of the coil 8 increases up to Va (C_{L}/L₃)^{1/2} in a sinusoidal manner. The time T₃ is π(L₃×C_{L})^{1/2}, as shown in the mathematical expression 1, that is, a half of that in the conventional drive method shown in FIG. 6 and therefore a high-speed drive can be realized. When the drive IC 70 is used, the current is taken out from the power supply terminal 700 via the parasitic diode 73 of the high-side MOSFET 71, therefore, it is possible to switch the states of the high-side MOSFET 71 and the low-side MOSFET 72 to speed up the circuit operation only by prohibiting the low-side MOSFET 72 from changing from the OFF-state to the ON-state. When the power supply voltage V_{H} of the drive IC 70 drops from Va to 0V, a diode 82 is brought into conduction, therefore, the voltage between the terminals of the coil 8 becomes nearly equal to 0V, the current I₃ is kept at Va (C_{L}/L₃)^{1/2}, and the electromagnetic energy is conserved. After this, the switch circuit 81 is brought into the OFF-state in preparation for the return of the electromagnetic energy to the drive circuit. Then, the switch circuit 4 is brought into the OFF-state. When the drive IC 70 is used, the switch circuit 4 is brought into the OFF-state after the output state switches to output (_{Ln+1}) Even in a case where it takes a long time for the output state to switch completely, the MOSFET 41 can be brought into the OFF-state only if the ON-state of the high-side MOSFET 71 within the drive IC 70 is maintained. The very instant that the current I₃ is about to decrease because the switch circuit 4 is brought into the OFF-state, a counter-electromotive force is produced in the direction that brings a diode 83 into conduction and the current I₃ decreases while describing a sinusoidal resonance waveform as shown schematically. If compared with T₃′, the resonance time T₃ is slightly longer or shorter, depending on the resistance in the path of the resonance current. Then, the switch circuit 2 is brought into the ON-state to supply the drive voltage Va to the drive load and the switch circuit 81 is brought into the ON-state in preparation for the subsequent repetitious operation.

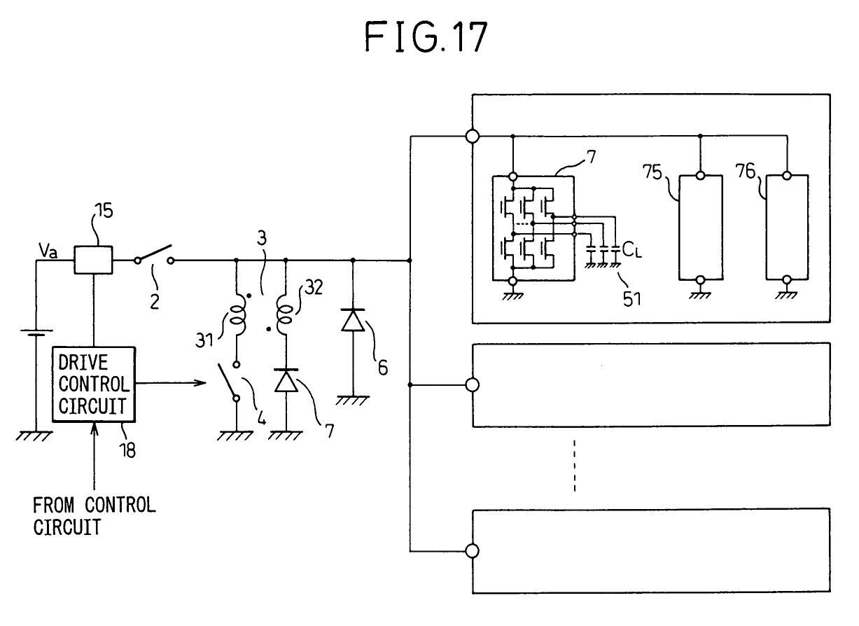

FIG. 17 is a diagram that shows the configuration of the address driver power recovery power supply in the sixth embodiment of the present invention. Each of the address driver power recovery power supplies in the first to the fourth embodiments described above can reduce the power consumption significantly when handling a display signal for a display pattern that changes considerably. However, in a case where a display signal, the change in display pattern of which is small, for example, a display signal corresponding to a monochromatic display pattern at the display front, is handled, the power consumption can be suppressed sufficiently even by the conventional method, and, if the above-mentioned embodiments are applied without any changes made to them, a drive pulse of high frequency is applied forcedly to the drive load 51 as a result, and the power consumption in the drive circuit increases, on the contrary, compared to the case of the conventional method.

Therefore, in the sixth embodiment, a detection circuit 15 for the power supply current is inserted in series between the drive power supply 1 and the switch circuit 2, and the output terminal of the current detection circuit 15 is connected to the input terminal of a drive control circuit 18. Then, for a display that only consumes power considerably in the drive circuit, the power recovery function is activated as before. In concrete terms, the power supply current flowing out of the drive power supply 1 is detected using the current detection circuit 15, the detected output is input to the control circuit 18, and the switch circuit 4 is activated when the current value exceeds a certain value.

Therefore, the current detection circuit 15 can be inserted to any position such as between the switch circuit 2 and the output terminal as long as the power supply current flowing out of the drive power supply 1 can be detected.

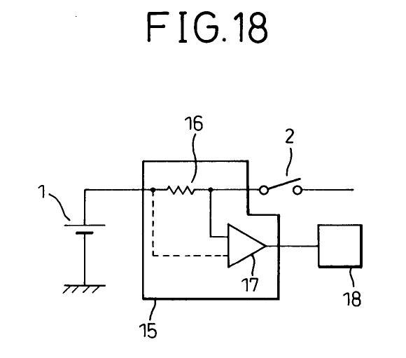

FIG. 18 is a diagram that shows an example of the configuration of the current detection circuit. In FIG. 18, the current detection circuit 15 is composed of a current detection resistor 16 and a detected voltage conversion circuit 17. The power supply current of the drive power supply 1 can be detected by the voltage drop across the current detection resistor 16 caused in proportion to the power supply current. The detected voltage conversion circuit 17 converts the detected voltage into a signal (voltage, current, pulse, etc.) that can be easily handled in the drive control circuit 18, and outputs it to the drive control circuit 18. The detected voltage conversion circuit 17 can detect the above-mentioned voltage drop only from the terminal that is not connected to the drive power supply 1 of the current detection resistor 16, with respect to the reference of the ground potential. Or, it can detect accurately from both terminals of the current detection resistor 16 even when the detected voltage is small, if the connection denoted by the broken line is added.

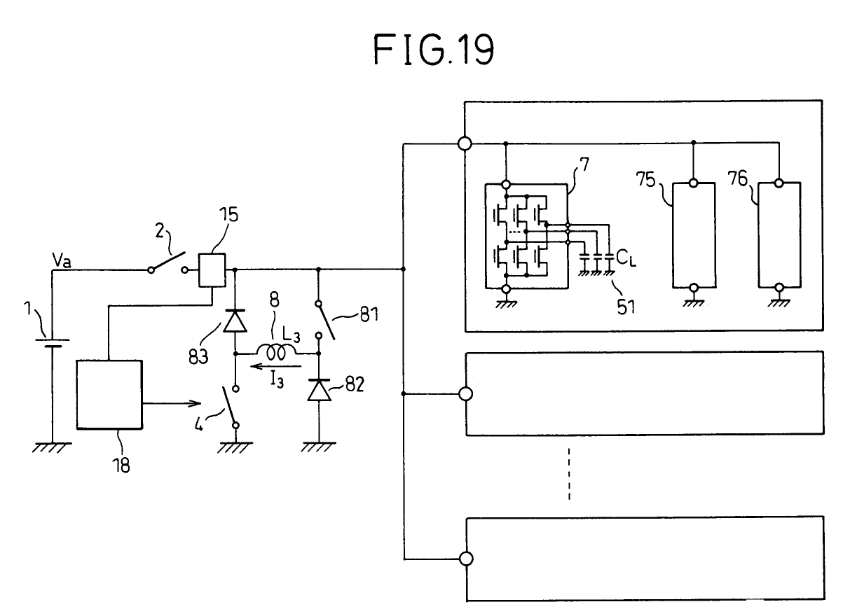

FIG. 19 is a diagram that shows the address driver power recovery power supply in the PDP apparatus in the seventh embodiment of the present invention, in which, similar to the sixth embodiment, the power supply current flowing out of the drive power supply 1 is detected and the switch circuit 4 is activated when the current valued exceeds a certain value in the PDP apparatus, in which the capacitive load drive circuit in the fifth embodiment shown in FIG. 15 is applied to the address driver power recovery power supply. In the seventh embodiment, the current detection circuit 15 is provided between the switch circuit 2 and the output terminal.

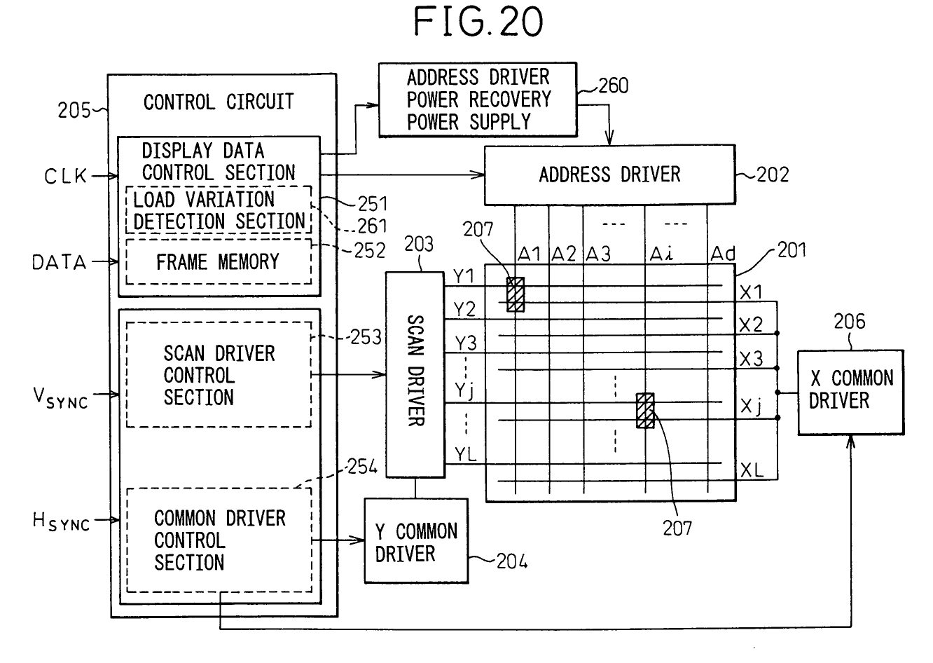

FIG. 20 is a diagram that shows the configuration of the PDP apparatus in the eighth embodiment of the present invention. Although the power supply current flowing out from the drive power supply 1 is detected in the sixth and seventh embodiments, the power consumption in the drive circuit can be estimated also by detecting the display signal in the PDP apparatus. In the PDP apparatus in the eighth embodiment, as shown in FIG. 20, the display data control section 251 in the control circuit 205 is provided with a load variation detection circuit 261 and the power recovery operation by the address driver power recovery power supply 260 is controlled on the basis of the detected result. The address driver power recovery power supply 260 is, for example, one of the circuits shown in the second to seventh embodiments.

The load variation detection section 261 estimates the power consumption of the drive circuit from the input clock signal and the display data signal. The load variation can be obtained by counting the number of output pulses of the individual address driver IC or the address drive module obtained from the clock signal and the display data signal. In accordance with the increase or decrease in the load variation, the power consumption in the drive circuit also increase or decreases. When the power consumption has to be estimated more accurately, the power consumption in the drive circuit is obtained by assigning weights of the following kind to the number of pulses, with the parasitic capacitance between neighboring output lines being taken into consideration. In other words, in accordance with the switching relation of the outputs between the neighboring output terminals and the output terminal that is the target of calculation, a heavier weight is assigned according to the following priority.

(1) The number of times the neighboring output terminals on both sides and the output terminal that is the target of calculation switch to a high level or a low level at the same time.

(2) The number of times only one of the neighboring output terminals and the output terminal that is the target of calculation switch to a high level or a low level at the same time and the other neighboring output terminal does not switch.

(3) The number of times only the output terminal that is the target of calculation switches and the neighboring output terminals on both sides do not switch.

(4) The number of times only one of the neighboring output terminals and the output terminal that is the target of calculation switch to levels opposite to each other at the same time and the other neighboring output terminal does not switch.

(5) The number of times both the neighboring output terminals on both sides and the output terminal that is the target of calculation switch to levels opposite to each other.

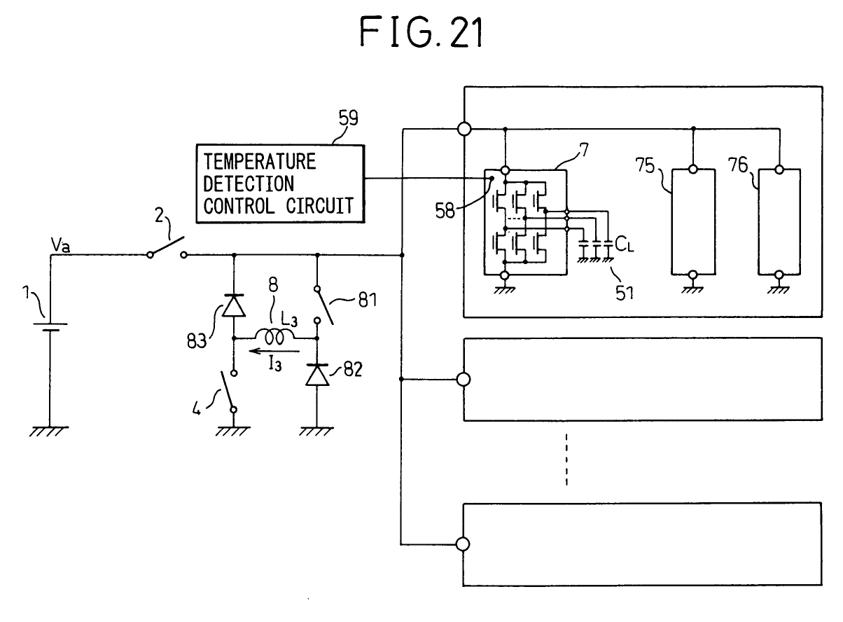

FIG. 21 a diagram that shows the configuration of the drive system of the address driver in the PDP apparatus in the ninth embodiment of the present invention, which is a case where the capacitive load drive circuit in the fifth embodiment is applied to the address driver power recovery power supply.

There can be another method for detecting the load variations in which the temperature of a device that consumes power in the drive circuit is detected. In other words, when a display pattern that consumes a large power in the circuit is displayed, the power consumption in the circuit increases and the temperature of the device or the ambient temperature rises. In the ninth embodiment, therefore, the circuit power consumption is reduced when a display pattern that requires a large circuit power consumption is displayed by activating the recovery operation of the address driver power recovery power supply when the detected temperature exceeds a certain value, and when the circuit power consumption is small, on the contrary, the circuit power consumption is prevented from increasing, without the recovery operation.

In the ninth embodiment, as shown in FIG. 21, the address drive IC 70 is provided with a temperature detector 58 such as a thermistor, and a temperature detection control circuit 59 detects the temperature from the detected signal of the temperature detector 58 and controls the operation of the switch circuit 4. In concrete terms, when the detected temperature exceeds a fixed value, the switch circuit 4 is prevented from operating by shutting off the control signal thereto.

Although the address drive IC 70 is provided with the temperature detector 58 such as a thermistor in the ninth embodiment, it is also possible to detect the temperature of a power consuming device directly or indirectly by mounting a temperature detector on the address drive module 77, a heat radiating board used for it, or a wiring member such as a flexible substrate provided on the heat radiating board, or by attaching it to a power consuming device or to its periphery by screwing or bonding. In addition to a thermistor, an IC for detecting temperature or the like can be used. Moreover, it is also possible to detect temperature by utilizing the temperature characteristic of the devices having a PN junction such as diodes or transistors, resistive elements, or condensers configured in the address drive IC, without using the temperature detector 58.

Moreover, there can be several methods for controlling the drive control circuit 18 and the temperature detection control circuit 59 described above. First, there can be a method in which the power consumption reducing function according to the present invention is activated immediately when the power consumed or the temperature detected in the drive circuit described above exceeds a certain threshold, and the operation is terminated when the power consumption or the temperature falls below the threshold. Although this method minimizes the size of the control program, there is possibility that switching noises may be discerned by the operator, which are produced when the power consumption reducing function is activated and terminated repeatedly each time the display pattern changes. To avoid this, therefore, there is another method in which the power consumption reducing function is activated or terminated a certain period after the threshold is exceeded or the value falls below the threshold. Still in this method, however, there is possibility that the operator may detect noise during display of a still image, which are produced when the power consumption reducing operations are switched. Therefore, there can be a method in which the power consumption operation is provided with a hysteresis characteristic by setting two thresholds. In other words, the power consumption reducing function according to the present invention is performed when the power consumed or the temperature detected in the drive circuit described above exceeds a first threshold and the power consumption reducing operation is terminated when the power consumption or the detected temperature falls below a second threshold, which is lower than the first threshold. Due to this hysteresis characteristic, the possibility that the noises are recognized is reduced because the power consumption reducing operations may be switched in synchronization with the change of images.

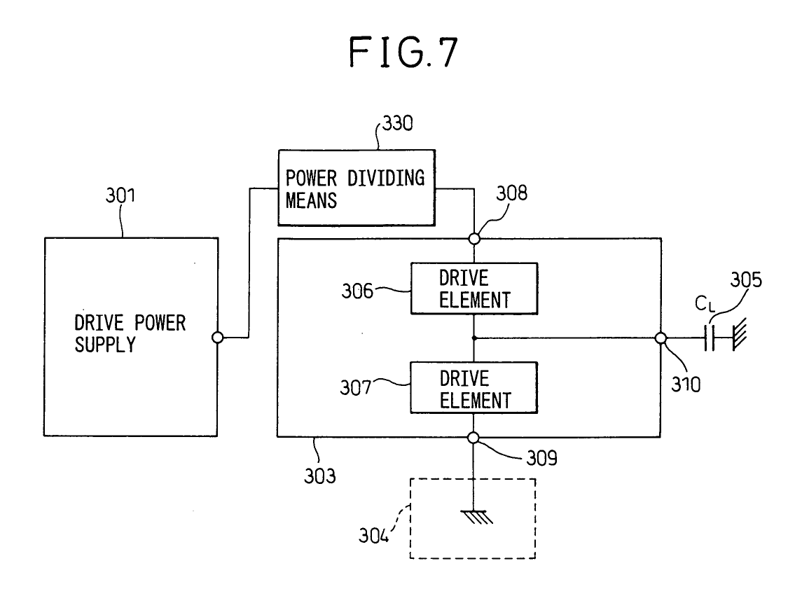

It is needless to say that the control over activation and termination of the power consumption reducing function according to the present invention on the basis of the power consumption of the drive circuit or the detected temperature of the device, as described above, can also be applied to the conventional drive circuit, the power consumption of which has been reduced, disclosed in Japanese Unexamined Patent Publication (Kokai) No. 5-249916 shown in FIG. 6 or in Japanese Patent Application No. 2000-301015 shown in FIG. 7.

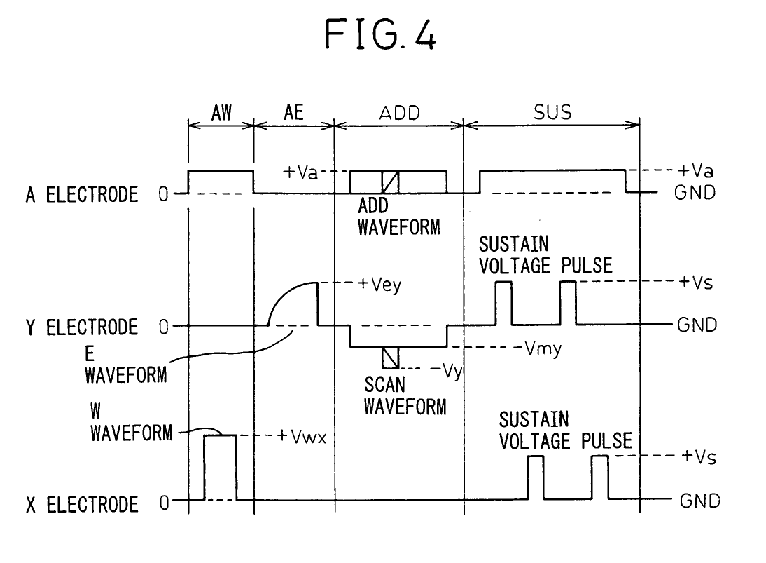

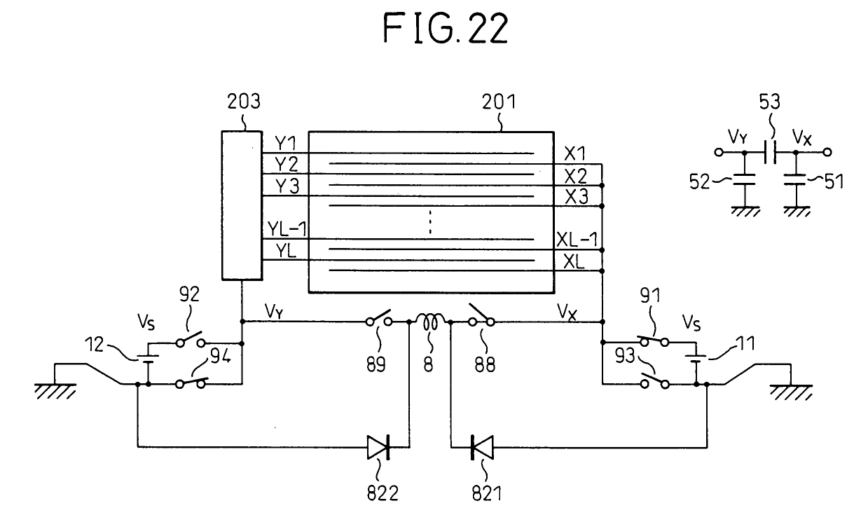

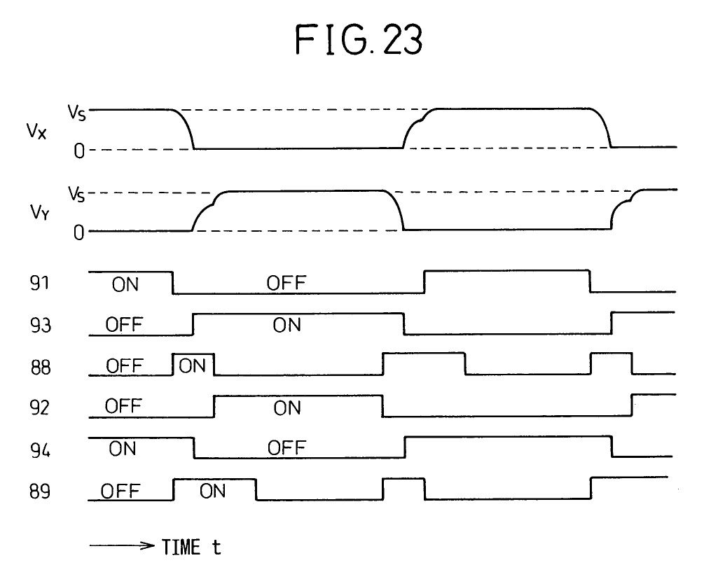

FIG. 22 is a diagram that shows the configuration of the part of the panel 201, the X common driver, the scan driver 203 and the Y common driver in the PDP apparatus in the tenth embodiment of the present invention. The sustain electrode drive circuit (X common driver and Y common driver (common driver, together)) in the plasma display panel 201 drives a capacitive load, the load capacitance of which can be regarded as constant. In the common driver in the tenth embodiment, a common drive voltage V_{Y} is applied to the Y electrodes Y1 to YL of the plasma display panel 201, shown in FIG. 22, via the drive module 203 on which the scan drive IC is mounted, and a common drive voltage V_{X} is also applied to the X electrodes X1 to XL during the sustain period, as shown in FIG. 4. For example, there can be a method for widening the margin to absorb the panel dependency of the drive voltage and for increasing the luminance of the display, in which the period during which the voltage being applied to the X electrodes and Y electrodes is 0V in the sustain period shown in FIG. 4 is shortened and the drive duty is increased. In order to obtain the maximum drive duty, there can be a method in which the X electrodes and the Y electrodes are switched simultaneously so that the potentials of both electrodes are always different. But, if the X electrodes and the Y electrodes are switched completely at the same time in an attempt to get the maximum improvement in performance, a voltage difference twice as large as the applied voltage Vs is applied, as a result, to an inter-electrode capacitance 53 in a load equivalent circuit shown in FIG. 22. In this case, the amount of power consumed to drive the inter-electrode capacitance 53 is doubled per pulse period. The amount of power required to drive the capacitance 51 between the X electrode and the ground, and the capacitance 52 between the Y electrode and the ground does not change. There is a method for obtaining the maximum improvement in performance without doubling the drive power for the inter-electrode capacitor 53, in which the very instant that one of the electrode voltages reaches 0V, the other electrode voltage is raised, as shown in the waveforms of the drive voltages V_{X} and V_{Y} in FIG. 23. This drive method is described briefly by reference to the diagram of waveforms in FIG. 23. For example, when the voltage V_{X} of the X electrode is lowered, switch circuits 88 and 89 are brought into the ON-state and the resonance between the coil 8 and the inter-electrode capacitance is utilized. When V_{X} falls below 0V, a diode 821 is brought into conduction and V_{X} is kept almost at 0V. Then, if a switch circuit 94 is brought into the OFF-state, the current flowing through the coil 8 begins to flow into the capacitance of the Y electrode of the plasma display panel 201. At this time, the power consumption can be reduced by reproducing the electromagnetic energy stored in the coil 8 into the electrostatic energy of the capacitance of the Y electrode, via the resonance between the coil 8 and the capacitance of the Y electrode. The same operation is repeated when the voltage V_{Y} of the Y electrode is raised. By using the present embodiment, it is possible to realize a fast low power consumption drive circuit able to widen the margin of the drive voltage and to increase the luminance of a display by increasing the pulse frequency.

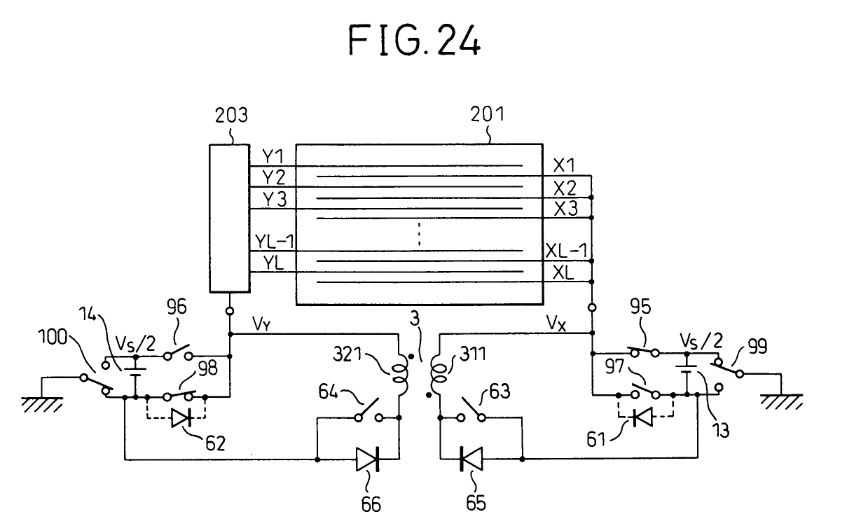

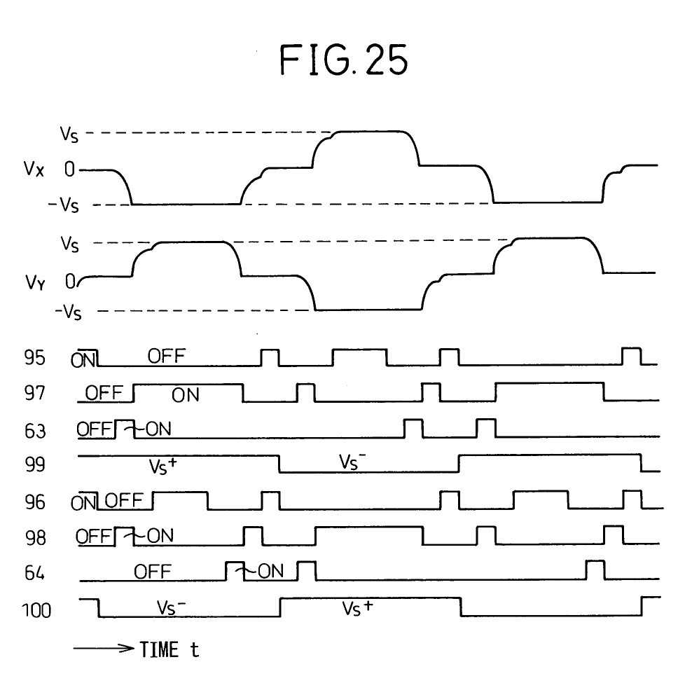

FIG. 24 is a diagram that shows the configuration of the part of the panel 201, the X common driver, the scan driver 203 and the Y common driver in the PDP apparatus in the eleventh embodiment. In drive circuit in the tenth embodiment, it is possible to further reduce the power consumption and the cost of the drive circuit, the load capacitance of which can be regarded as constant, as similar to the common driver in the plasma display panel 201. During the sustain period, as shown in FIG. 4, the common drive voltage V_{Y} is applied to the Y electrodes Y1 to YL of the plasma display panel 201 shown in FIG. 24 via the drive module 203 on which the scan drive IC is mounted and, also, the common drive voltage V_{X} is applied to the X electrodes X1 to XL. In general, the power consumption in the drive circuit is almost proportional to the second power of the drive voltage and the drive frequency. Therefore, if ±Va is applied, as is conventionally done, between the X and Y electrodes of the plasma display panel 201 while the amplitude of the drive pulse of V_{X} and V_{Y} is being kept at Va/2, that is, a half of the conventional one, as shown in the waveform diagram in FIG. 25, the power consumption in the drive circuit can be halved. In this case, even if the pulse frequency is doubled, the consumed energy per pulse period becomes ¼. In the present embodiment, it is also possible to widen the duty of the drive voltage waveform to the maximum by raising the other electrode voltage the very instant that one of the electrode voltages reaches its minimum voltage, as shown in the waveforms of the drive voltage V_{X} and V_{Y} in FIG. 25. Therefore, it is possible to widen the margin of the drive voltage and to increase the luminance of the display by increasing the pulse frequency. The operation is described briefly by reference to the waveforms shown in FIG. 25. For example, when the voltage V_{X} of the X electrode is lowered, after a switch circuit 95 is brought into the OFF-state, a switch circuit 63 is brought into the ON-state and then the resonance between a coil 311, which is on one of the sides of the transformer 3, and the electrode capacitance. When V_{X} falls below the minimum potential of the pulse waveform, a diode 61 is brought into conduction and V_{X} is kept almost at the minimum potential. A parasitic diode in an element making up a switch circuit 97 or a diode newly loaded in parallel can be used instead of the diode 61. Then, when the switch circuit 63 is brought into the OFF-state, the current flowing through the coil 311 is shut off and the electromagnetic energy in the transformer 3 flows into the Y electrode of the plasma display panel 201 via the other coil 321 and a diode 66. At this time also, the power consumption in the drive circuit can be reduced by efficiently converting and reproducing the electromagnetic energy stored in the transformer 3 into the electrostatic energy of the capacitance of the Y electrode, via the resonance between the coil 321 and the capacitance of the Y electrode. The same operation is performed repeatedly when lowering the voltages V_{X} and V_{Y} of the X and Y electrodes by switching floating switch circuits 99 and 100. (There are four patterns, because each electrode voltage is lowered from VA/2 and 0V, respectively.)

Moreover, in the present embodiment, it is possible to use inexpensive drive devices, diodes, and transformers, the withstand voltage of which have been halved, in each switch circuit or as circuitry parts. Although the drive voltage, the amplitude of which is halved, is applied differentially between the X electrode and the Y electrode of the plasma display panel 201 in the description of the present embodiment, it is needless to say that the drive voltage can be applied between terminals of the same X electrode or between an odd-numbered terminal and an even-numbered one of the Y electrodes. Therefore, by using the present embodiment, it is possible to realize a fast low-power consumption drive circuit able to wide the margin of the drive voltage or to increase the luminance of a display by increasing the pulse frequency while suppressing the power consumption and the cost of the drive circuit significantly.

The embodiments of the present invention are described as above, but it is needless to say that the positive and negative directions of the power supply voltage can be reversed by reversing the polarities of the elements making up each embodiment. Although MOSFETs or diodes are used as the drive devices and the semiconductor devices making up each embodiment, it is also needless to say that those skilled in the art can replace those devices with IGBTs, bipolar transistors, junction type FET'S, vacuum tubes, and so on, which can be regarded as equivalents. Similarly, it is apparent that each embodiment can be applied to a plasma display panel, a liquid crystal panel, an electro-luminescent panel, a field emission display (FED) panel, and so on, which have a matrix electrode and which can be regarded as a capacitive load, in addition to the plasma display panel that is the target to be driven. Moreover, Braun tubes or fluorescent tubes (those used as a backlight of a liquid crystal display are also included), the drive load of which shows a capacitive impedance, are included as the drive load in the present invention.

According to the present invention, it is possible to suppress the power consumption (heat generation) in a drive circuit that drive a display device at high speed, and at the same time to suppress an increase in the circuitry cost. By applying the present invention, it is possible to reduce the size, power consumption, and the cost of a plasma display of 40′ or larger type having a large load capacitance, a high resolution plasma display with a high address drive pulse rate such as SVGA (800×600 dots), XGA (1024×768 dots), and SXGA (1280×1024 dots), and a high luminance plasma television with a high gradation such as TV and HDTV. Moreover, it is possible to suppress an increase in the power consumption due to the increase in the address drive pulse rate accompanying the measures against false contour during video display.

We claim:

1. A capacitive load drive recovery circuit comprising:
a transformer having a primary coil connected between an output terminal to be connected to a capacitive load and a first reference potential and a secondary coil connected to the output terminal and a second reference potential;
a first switch circuit connected in series to the primary coil;
a second switch circuit connected in series to the secondary coil; and
a power supply switch circuit connected between the output terminal and a drive power supply.

2. A capacitive load drive recovery circuit, as set forth in claim 1, further comprising a third switch circuit connected between the output terminal and the first reference potential.

3. A capacitive load drive recovery circuit, as set forth in claim 2, wherein the third switch circuit is composed of a one-way conductive element.

4. A capacitive load drive recovery circuit, as set forth in claim 1, wherein the second switch circuit is composed of a one-way conductive element.

5. A capacitive load drive recovery circuit, as set forth in claim 1, wherein the first reference potential and the second reference potential are equal.

6. A capacitive load drive recovery circuit, as set forth in claim 1, further comprising: a fourth switch circuit connected between the connection point where the primary coil and the first switch are connected; and a fifth reference potential.

7. A capacitive load drive recovery circuit, as set forth in claim 1, further comprising: a fourth switch circuit connected between the connection point where the primary coil and the first switch are connected; and the drive power supply.

8. A capacitive load drive recovery circuit, as set forth in claim 6, wherein the fourth switch circuit is composed of a one-way conductive element.

9. A capacitive load drive recovery circuit, as set forth in claim 1, further comprising an impedance circuit connected to a path to which the power supply switch circuit is connected.

10. A capacitive load drive recovery circuit comprising:
a first switch circuit, a coil and a second switch circuit connected in series between an output terminal connected to a capacitive load and a first reference potential;
a third switch circuit connected between the connection point where the first switch circuit and the coil are connected, and the first reference potential;
a fourth switch circuit connected between the connection point where the coil and the second switch circuit are connected, and the output terminal; and
a power supply switch circuit connected between the output terminal and a drive power supply.

11. A capacitive load drive recovery circuit, as set forth in claim 10, wherein the third switch circuit is composed of a one-way conductive element.

12. A capacitive load drive recovery circuit, as set forth in claim 10, wherein the fourth switch circuit is composed of a one-way conductive element.

13. A capacitive load drive recovery circuit, as set forth in claim 10, further comprising an impedance circuit connected to a path to which the power supply switch circuit is connected.

14. A capacitive load drive circuit comprising:
a plurality of capacitive loads;
a first drive power supply;
a second drive power supply; and
a plurality of pairs of first and second drive elements connected in series between the first drive power supply and the second drive power supply, driving the plurality of capacitive loads, respectively, and the connection point of which is being connected to the capacitive loads,
wherein either one of the first and second drive power supplies is the capacitive load drive recovery circuit set forth in claim 1.

15. A capacitive load drive circuit comprising:
a plurality of capacitive loads;
a first drive power supply;
a second drive power supply; and
a plurality of pairs of first and second drive elements connected in series between the first drive power supply and the second drive power supply, driving the plurality of capacitive loads, respectively, and the connection point of which is being connected to the capacitive loads,
wherein either one of the first and second drive power supplies is the capacitive load drive recovery circuit set forth in claim 10.

16. A capacitive load drive circuit, as set forth in claim 14, further comprising: a current detection circuit being provided in a path to which the power supply switch circuit of the capacitive load drive recovery circuit used as one of the first and second drive power supplies and detecting a current flowing out from the drive power supply; and a control circuit controlling each switch circuit of the capacitive load drive recovery circuit according to the detection result of the current detection circuit.

17. A capacitive load drive circuit, as set forth in claim 15, further comprising: a current detection circuit being provided in a path to which the power supply switch circuit of the capacitive load drive recovery circuit used as one of the first and second drive power supplies and detecting a current flowing out from the drive power supply; and a control circuit controlling each switch circuit of the capacitive load drive recovery circuit according to the detection result of the current detection circuit.

18. A capacitive load drive circuit, as set forth in claim 14, further comprising a control circuit calculating an estimated value of power consumption in a drive circuit from information about changes in each drive state of the plurality of capacitive loads and controlling each switch circuit of the capacitive load drive recovery circuit according to the calculated estimated value of the power consumption.

19. A capacitive load drive circuit, as set forth in claim 15, further comprising a control circuit calculating an estimated value of power consumption in a drive circuit from information about changes in each drive state of the plurality of capacitive loads and controlling each switch circuit of the capacitive load drive recovery circuit according to the calculated estimated value of the power consumption.

20. A capacitive load drive circuit, as set forth in claim 14, further comprising: a temperature detection circuit detecting temperature of a part of the capacitive load drive circuit; and
a control circuit controlling each switch circuit of the capacitive load drive recovery circuit according to the temperature detected by the temperature detection circuit.

21. A capacitive load drive circuit, as set forth in claim 15, further comprising: a temperature detection circuit detecting temperature of a part of the capacitive load drive circuit; and
a control circuit controlling each switch circuit of the capacitive load drive recovery circuit according to the temperature detected by the temperature detection circuit.

22. A plasma display apparatus comprising:
a plasma display panel having a plurality of scan electrodes extending in a first direction and a plurality of address electrode arranged so as to intersect the scan electrodes;
a scan electrode drive circuit driving the plurality of scan electrodes; and
an address electrode drive circuit driving the plurality of address electrodes,
wherein the power supply of the address electrode drive circuit is the capacitive load drive recovery circuit set forth in claim 1.

23. A plasma display apparatus comprising:
a plasma display panel having a plurality of scan electrodes extending in a first direction and a plurality of address electrode arranged so as to intersect the scan electrodes;
a scan electrode drive circuit driving the plurality of scan electrodes; and
an address electrode drive circuit driving the plurality of address electrodes,
wherein the power supply of the address electrode drive circuit is the capacitive load drive recovery circuit set forth in claim 10.

24. A capacitive load drive circuit comprising:
a plurality of capacitive loads;
a first drive power supply;
a second drive power supply; and
a plurality of pairs of first and second drive elements connected in series between the first drive power supply and the second drive power supply, and the connection point of which is connected to the plurality of capacitive loads, respectively,
wherein either one of the first and second drive power supplies is a power recovery power supply equipped with a reactive power recovery circuit, and
wherein the power recovery power supply comprises a power detection circuit detecting power consumption in the drive circuit and a control circuit controlling the action of the reactive power recovery circuit according to the detection result of the power detection circuit.

25. A capacitive load drive circuit, as set forth in claim 24, wherein the power detection circuit comprises a current detection circuit detecting a current to be supplied to the power recovery power supply and calculates power consumption in the drive circuit according to the detection result of the current detection circuit.

26. A capacitive load drive circuit, as set forth in claim 24, wherein the power detection circuit calculates power consumption in the drive circuit from information about changes in each drive state of the plurality of capacitive loads.

27. A capacitive load drive circuit, as set forth in claim 24, wherein the power detection circuit comprises a temperature detection circuit detecting the temperature of a part of the drive circuit and calculates a power consumption in the drive circuit according to the temperature detected by the temperature detection circuit.

28. A capacitive load drive circuit comprising:
a capacitive load having two drive terminals;
a first drive power supply;
a second drive power supply;
a first switch circuit, a coil and a second switch circuit connected in series between the two terminals of the capacitive load;
a third switch circuit connected between either terminal of the capacitive load and either terminal of the first drive power supply;
a fourth switch circuit connected between either terminal of the capacitive load and the other terminal of the first drive power supply;
a fifth switch circuit connected between the connection point where the first switch and the coil are connected, and the other terminal of the first drive power supply;
a sixth switch circuit connected between the other terminal of the capacitive load and either terminal of the second drive power supply;
a seventh switch circuit connected between the other terminal of the capacitive load and the other terminal of the second drive power supply; and
an eighth switch circuit connected between the connection point where the second switch and the coil are connected, and the other terminal of the second drive power supply.

29. A capacitive load drive circuit comprising:
a capacitive load having two drive terminals;
a first drive power supply;
a second drive power supply;
a first switch circuit connected between either terminal of the capacitive load and either terminal of the first drive power supply;
a second switch circuit connected between either terminal of the capacitive load and the other terminal of the first drive power supply;
either coil of a transformer and a third switch circuit connected in series between either terminal of the capacitive load and the other terminal of the first drive power supply;
a fourth switch circuit connecting the two terminals of the first drive power supply selectively to a first reference potential;
a fifth switch circuit connected in parallel to the second switch circuit;
a sixth switch circuit connected in parallel to the third switch circuit;
a seventh switch circuit connected between the other terminal of the capacitive load and either terminal of the second drive power supply;
an eighth switch circuit connected between the other terminal of the capacitive load and the other terminal of the second drive power supply;
the other coil of the transformer and a ninth switch circuit connected in series between the other terminal of the capacitive load and the other terminal of the second drive power supply;
a tenth switch circuit connecting the two terminals of the second drive power supply selectively to a first reference potential;
an eleventh switch circuit connected in parallel to the eighth switch circuit; and
a twelfth switch circuit connected in parallel to the ninth switch circuit.

30. A plasma display apparatus comprising:
a plasma display panel having a plurality of first and second electrodes arranged alternately and extending in a first direction and a plurality of address electrodes arranged so as to intersect the first and second electrodes;
a first electrode drive circuit driving the plurality of the first electrodes;
a second electrode drive circuit driving the plurality of the second electrodes; and
an address electrode drive circuit driving the plurality of the address electrodes,
wherein the second electrode drive circuit comprises a scan circuit applying a scan pulse sequentially to the plurality of the second electrodes and a common drive circuit applying a sustain pulse simultaneously to the plurality of the second electrodes via the scan circuit,
wherein the first electrode drive circuit and the common drive circuit are plasma display apparatuses applying the sustain pulse alternately to the plurality of the first and second electrodes, and
wherein the first electrode drive circuit and the common drive circuit are the capacitive load drive circuits as set forth in claim 28.

31. A plasma display apparatus comprising:
a plasma display panel having at least a pair of electrodes making up a capacitive load and causing discharge to occur between the pair of electrodes; and
a capacitive load drive circuit connected at least either electrode of the pair of electrodes and driving the capacitive load,
wherein the capacitive load drive circuit has a coil circuit connected between an output terminal to be connected to the one of electrodes and a reference potential and controls so that when the energy stored in the capacitive load is discharged, the energy is stored in the coil circuit and at the same time the energy is retained in the coil circuit while the current flowing through the coil circuit is increasing, and when the capacitive load is recharged, the stored energy is released while the current flowing through the coil circuit is decreasing.

32. A plasma display apparatus, as set forth in claim 31, wherein a switch circuit maintaining the discharged state of the capacitive load after the capacitive load is discharged and until it is recharged, and a power supply switch circuit maintaining the charged state of the capacitive load after the capacitive load is charged and until it is discharged again.

33. A plasma display apparatus, as set forth in claim 32, wherein the switch circuit is composed of a one-way conductive element.

34. A plasma display apparatus, as set forth in claim 32, wherein the power supply switch circuit is controlled so as to be brought into a conductive state before the charging of the capacitive load is completed.

35. A plasma display apparatus, as set forth in claim 32, wherein the energy is stored in the coil circuit via the one of the electrodes when the energy stored in the capacitive load is discharged and the released energy is supplied to the capacitive load via the one of the electrodes when the capacitive load is recharged.

36. A plasma display apparatus, as set forth in claim 32, wherein the capacitive load drive circuit is connected between the one of electrodes and the other of the pair of electrodes, stores the energy in the coil circuit via the one of electrodes when the energy stored in the capacitive load is discharged, and supplies the released energy to the capacitive load via the other electrode when the capacitive load is recharged.

37. A plasma display apparatus comprising:
a plasma display panel having a plurality of scan electrodes and a plurality of address electrodes arranged so as to intersect the scan electrodes;
a scan electrode drive circuit driving the plurality of scan electrodes; and
an address electrode drive circuit driving the plurality of address electrodes,
wherein the address electrode drive circuit has a coil circuit connected between an output terminal to be connected to the address electrode and a reference potential and controls so that when the energy stored in the capacitive load consisting of the address electrodes and the scan electrodes is discharged, the energy is stored in the coil circuit and at the same time the energy is retained in the coil circuit while the current flowing through the coil circuit is increasing, and when the capacitive load is recharged, the stored energy is released while the current flowing through the coil circuit is decreasing.
